(19) United States
(12) Patent Application Publication
(10) Pub. No.: US 2010/0154826 A1
(43) Pub. Date: Jun. 24, 2010

(54) System and Method For Rinse Optimization

(75) Inventor: Wallace P. Printz, Austin, TX (US)

Correspondence Address: Tokyo Electron U.S. Holdings, Inc., 4350 West Chandler Blvd., Suite 10/11, Chandler, AZ, 85226, US

(73) Assignee: Tokyo Electron Limited, Tokyo (JP)

(21) Appl. No.: 12/339,273

(22) Filed: Dec. 19, 2008

(51) Int. Cl. B08B 7/04

(52) U.S. Cl. 134/18

(57) ABSTRACT

Embodiments of the invention provide optimized rinse systems and methods for providing rinsing solutions to one or more surfaces of semiconductor wafers. Embodiments of the invention may be applied to process wafers at different points in a manufacturing cycle, and the wafers can include one or more metal layers.

### FIELD OF THE INVENTION

The invention relates to wafer processing, and more particularly, to an Optimized Rinse System and method for using the same.

### BACKGROUND OF THE INVENTION

In the semiconductor process step-flow, after exposure the latent image must be chemically developed to remove exposed patterns in the resist substrate. After the develop chemical is applied to the resist surface, a deionized water rinse step is used to remove develop chemical from the wafer surface. Often, chemical residue, either partially-dissolved exposed-resist components or precipitates from the develop solution, is redeposited on the resist surface during the water rinse. Specifically, residue is often but not exclusively found in non-exposed areas adjacent to exposed areas. Furthermore, water droplets left on a resist surface, even one that was never exposed or developed, can leach resist components into the droplet and then said components deposit onto the resist surface during droplet evaporation.

Several strategies have been employed to attempt to reduce the deposition of droplets and increase the effectiveness of removing surface contamination from resist. This invention is an extension of previous efforts by using a novel calculation method to identify a droplet-formation mechanism and use such knowledge to avoid operating in a condition where droplets can be formed.

### SUMMARY OF THE INVENTION

Embodiments of the invention provide optimized rinse systems, subsystem, and procedures for providing one or more rinsing solutions to one or more surfaces of semiconductor wafers to remove surface contamination after the develop processing. Embodiments of the invention eliminate defects caused by water droplets are left on the resist surface after rinse treatment. Embodiments of the invention may be applied to process wafers at different points in a manufacturing cycle, and the wafers can include one or more metal layers.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a top view of a schematic diagram of a coating/developing processing system for use in accordance with embodiments of the invention;

FIG. 2 is a front view of the coating/developing processing system of FIG. 1;

FIG. 3 is a partially cut-away back view of the coating/developing processing system of FIG. 1, as taken along line 3-3;

FIGS. 4a-4b show exemplary schematic views of a rinsing system in accordance with embodiments of the invention;

FIG. 5 illustrates a simplified process flow diagram for a method for using a rinsing system according to embodiments of the invention;

FIG. 6 illustrates an exemplary Design of Experiments (DOE) data table in accordance with embodiments of the invention;

FIGS. 7A and 7B illustrate exemplary DOE data in accordance with embodiments of the invention;

FIGS. 8A and 8B illustrate additional exemplary DOE data in accordance with embodiments of the invention;

FIG. 9 illustrates exemplary defect radius data in accordance with embodiments of the invention;

FIGS. 10A-10E illustrate exemplary nozzle scan speed data in accordance with embodiments of the invention;

FIGS. 11A and 11B illustrate exemplary recipe throughput optimization data in accordance with embodiments of the invention; and

FIG. 12 illustrates exemplary wafer rotation and nozzle scan speed optimization data in accordance with embodiments of the invention.

### DETAILED DESCRIPTION

Embodiments of the invention provide rinsing systems, subsystems, and procedures for removing edge-bead material from one or more surfaces of semiconductor wafers using rinsing systems. Embodiments of the invention may be applied to process wafers at different points in a manufacturing cycle, and the wafers can include one or more metal layers. The terms “wafer” and “substrate” are used interchangeably herein to refer to a thin slice of material, such as a silicon crystal or glass material, upon which microcircuits are constructed, for example by diffusion, deposition, and etching of various materials.

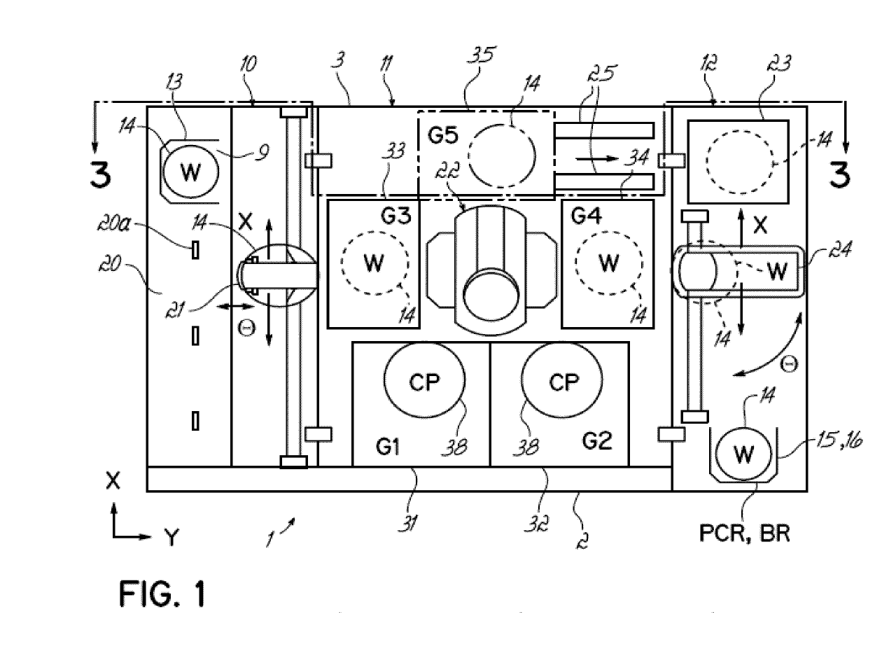

With reference to FIGS. 1-3, a coating/developing processing system 1 has a load/unload section 10, a process section 11, and an interface section 12. The load/unload section 10 has a cassette table 20 on which cassettes 13, each storing a plurality of semiconductor wafers (W) 14 (for example, 25), are loaded and unloaded from the processing system 1. The process section 11 has various single wafer processing units for processing wafers 14 sequentially one by one. These processing units are arranged in predetermined positions of multiple stages, for example, within first (G1), second (G2), third (G3), fourth (G4) and fifth (G5) multiple-stage process unit groups 31, 32, 33, 34, 35. The interface section 12 is interposed between the process section 11 and one or more light exposure systems (not shown), and is configured to transfer resist coated wafers between the process section. The one or more light exposure systems can include a resist patterning system such as a photolithography tool that transfers the image of a circuit or a component from a mask onto a resist on the wafer surface.

The coating/developing processing system 1 also includes a CD metrology system for obtaining CD metrology data from test areas on the patterned wafers. The CD metrology system may be located within the processing system 1, for example at one of the multiple-stage process unit groups 31, 32, 33, 34, 35. The CD metrology system can be a light scattering system such as an optical digital Profilometry (ODP) system.

The ODP system may include an optical metrology system and ODP software commercially available from Timbre Technologies Inc. (2953 Bunker Hill Lane, Santa Clara, Calif. 95054).

When performing optical metrology, such as Scatterometry, a structure on a substrate, such as a semiconductor wafer or flat panel, is illuminated with electromagnetic (EM) radiation, and a diffracted signal received from the structure is utilized to reconstruct the profile of the structure. The structure may include a periodic structure, or a non-periodic structure. Additionally, the structure may include an operating structure on the substrate (i.e., a via, or contact hole, or an interconnect line or trench, or a feature formed in a mask layer associated therewith), or the structure may include a periodic grating or non-periodic grating formed proximate to an operating structure formed on a substrate. For example, the periodic grating can be formed adjacent a transistor formed on the substrate. Alternatively, the periodic grating can be formed in an area of the transistor that does not interfere with the operation of the transistor. The profile of the periodic grating is obtained to determine whether the periodic grating, and by extension the operating structure adjacent the periodic grating, has been fabricated according to specifications.

Still referring to FIGS. 1-3, a plurality of projections 20a are formed on the cassette table 20. A plurality of cassettes 13 are each oriented relative to the process section 11 by these projections 20a. Each of the cassettes 13 mounted on the cassette table 20 has a load/unload opening 9 facing the process section 11.

The load/unload section 10 includes a first sub-arm mechanism 21 that is responsible for loading/unloading the wafer W into/from each cassette 13. The first sub-arm mechanism 21 has a holder portion for holding the wafer 14, a back and forth moving mechanism (not shown) for moving the holder portion back and forth, an X-axis moving mechanism (not shown) for moving the holder portion in an X-axis direction, a Z-axis moving mechanism (not shown) for moving the holder portion in a Z-axis direction, and a θ (theta) rotation mechanism (not shown) for rotating the holder portion around the Z-axis. The first sub-arm mechanism 21 can gain access to an alignment unit (ALIM) 41 and an extension unit (EXT) 42 belonging to a third (G3) process unit group 33, as further described below.

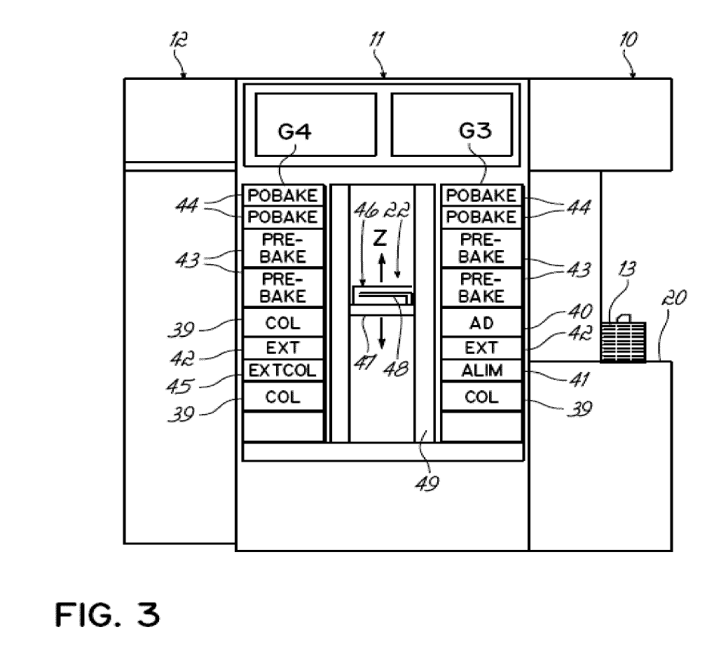

With specific reference to FIG. 3, a main arm mechanism 22 is liftably arranged at the center of the process section 11. The process units G3-G4 are arranged around the main arm mechanism 22. The main arm mechanism 22 is arranged within a cylindrical supporting body 49 and has a liftable wafer transporting system 46. The cylindrical supporting body 49 is connected to a driving shaft of a motor (not shown). The driving shaft may be rotated about the Z-axis in synchronism with the wafer transporting system 46 by an angle of θ. The wafer transporting system 46 has a plurality of holder portions 48 movable in a front and rear direction of a transfer base table 47.

Units belonging to first (G1) and second (G2) process unit groups 31, 32, are arranged at the front portion 2 of the coating/developing processing system 1. Units belonging to the third (G3) process unit group 33 are arranged next to the load/unload section 10. Units belonging to a fourth (G4) process unit group 34 are arranged next to the interface section 12. Units belonging to a fifth (G5) process unit group 35 are arranged in a back portion 3 of the processing system 1.

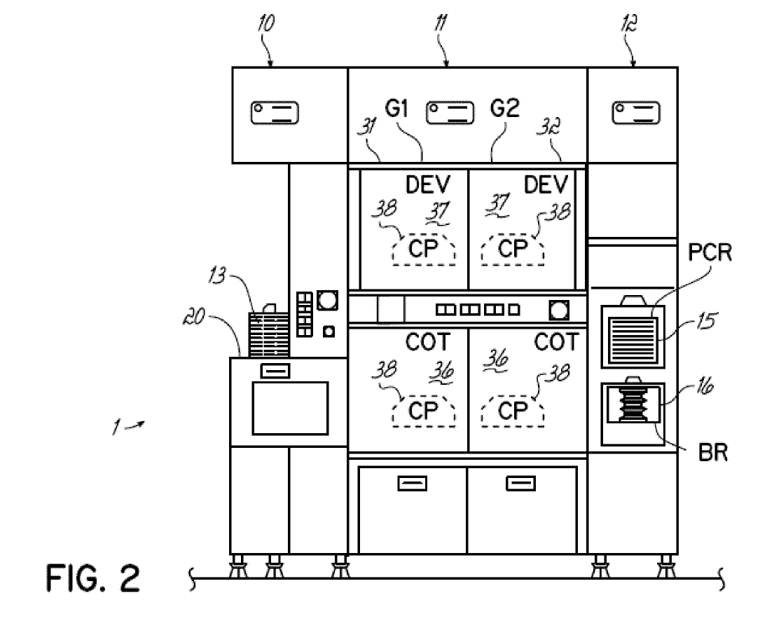

With reference to FIGS. 1 and 2, the first (G1) process unit group 31 has two spinner-type process units for applying a predetermined treatment to the wafer 14 mounted on a spin chuck (not shown) within the cup (CP) 38. In the first (G1) process unit group 31, for example, a resist coating unit (COT) 36 and a developing unit (DEV) 37 are stacked in two stages sequentially from the bottom. In the second (G2) process unit group 32, two spinner type process units such as a resist coating unit (COT) 36 and a developing unit (DEV) 37, are stacked in two stages sequentially from the bottom. In an exemplary embodiment, the resist coating unit (COT) 36 is set at a lower stage than the developing unit (DEV) 37 because a discharge line (not shown) for the resist waste solution is desired to be shorter than a developing waste solution for the reason that the resist waste solution is more difficult to discharge than the developing waste solution. However, if necessary, the resist coating unit (COT) 36 may be arranged at an upper stage relative to the developing unit (DEV) 37.

With reference to FIGS. 1 and 3, the third (G3) process unit group 33 has a cooling unit (COL) 39, an alignment unit (ALIM) 41, an adhesion unit (AD) 40, an extension unit (EXT) 42, two prebaking units (PREBAKE) 43, and two postbaking units (POBAKE) 44, which are stacked sequentially from the bottom.

Similarly, the fourth (G4) process unit group 34 has a cooling unit (COL) 39, an extension-cooling unit (EXTCOL) 45, an extension unit (EXT) 42, another cooling unit (COL) 39, two prebaking units (PREBAKE) 43 and two postbaking units (POBAKE) 44 stacked sequentially from the bottom. Although, only two prebaking units 43 and only two postbaking units 44 are shown, G3 and G4 may contain any number of prebaking units 43 and postbaking units 44. Furthermore, any or all of the prebaking units 43 and postbaking units 44 may be configured to perform PEB, post application bake (PAB), and post developing bake (PDB) processes.

In an exemplary embodiment, the cooling unit (COL) 39 and the extension cooling unit (EXTCOL) 45, to be operated at low processing temperatures, are arranged at lower stages, and the prebaking unit (PREBAKE) 43, the postbaking unit (POBAKE) 44 and the adhesion unit (AD) 40, to be operated at high temperatures, are arranged at the upper stages. With this arrangement, thermal interference between units may be reduced. Alternatively, these units may have different arrangements.

At the front side of the interface section 12, a movable pick-up cassette (PCR) 15 and a non-movable buffer cassette (BR) 16 are arranged in two stages. At the backside of the interface section 12, a peripheral light exposure system 23 is arranged. The peripheral light exposure system 23 can contain a lithography tool or and ODP system. Alternately, the lithography tool and the ODP system may be remote to and cooperatively coupled to the coating/developing processing system 1. At the center portion of the interface section 12, a second sub-arm mechanism 24 is provided, which is movable independently in the X and Z directions, and which is capable of gaining access to both cassettes (PCR) 15 and (BR) 16 and the peripheral light exposure system 23. In addition, the second sub-arm mechanism 24 is rotatable around the Z-axis by an angle of θ and is designed to be able to gain access not only to the extension unit (EXT) 42 located in the fourth (G4) processing unit group 34 but also to a wafer transfer table (not shown) near a remote light exposure system (not shown).

In the processing system 1, the fifth (G5) processing unit group 35 may be arranged at the back portion 3 of the backside of the main arm mechanism 22. The fifth (G5) processing unit group 35 may be slidably shifted in the Y-axis direction along a guide rail 25. Since the fifth (G5) processing unit group 35 may be shifted as mentioned, maintenance operation may be applied to the main arm mechanism 22 easily from the backside.

The prebaking unit (PREBAKE) 43, the postbaking unit (POBAKE) 44, and the adhesion unit (AD) 40 each comprise a heat treatment system in which wafers 14 are heated to temperatures above room temperature.

In some embodiments, the coating/developing processing system 1 can include one or more rinsing systems that may be incorporated into the coating/developing processing system 1, or be incorporated as additional modules.

Previous efforts in improving the rinse process have identified a reduction in post-processing defects by changing the wafer rotation rate during the time the nozzle is scanned from the wafer center to wafer edge.

A wafer rinsing process utilizing a continuously changing rotation rate formula showed improved defect reduction results, however the wafer was still not optimally cleaned. After processing and defect measurement, generally two regions of the wafer were identified: an inner region relatively defect free and an outer region relatively high in defects. The transition point between low and high defect regions occurred at a specific radius and this radius was a function of both nozzle scan speed and wafer rotation rate. Generally, within a rinse recipe, an increase in wafer rotation rate and/or a reduction in nozzle scan speed will result in reduced defect formation.

The inventor has developed a new set of equations that combine the nozzle scan speed and wafer rotation rate, such that a distance the nozzle travels during one rotation is calculated. The nozzle movement per rotation (hereafter “NMpR”) can be calculated at all radial positions for any combination of nozzle scan speed and wafer rotation rate.

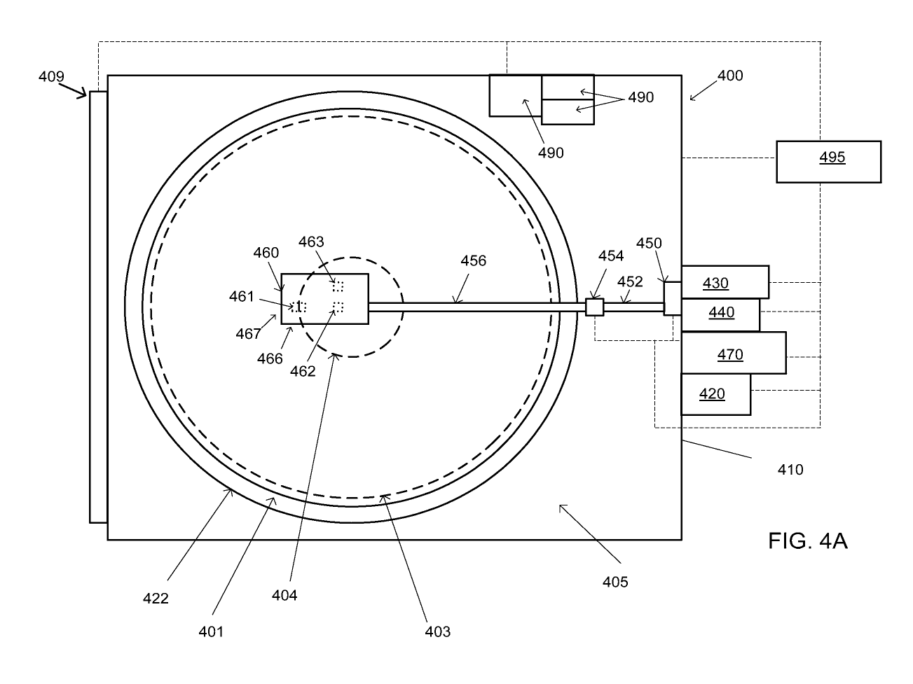

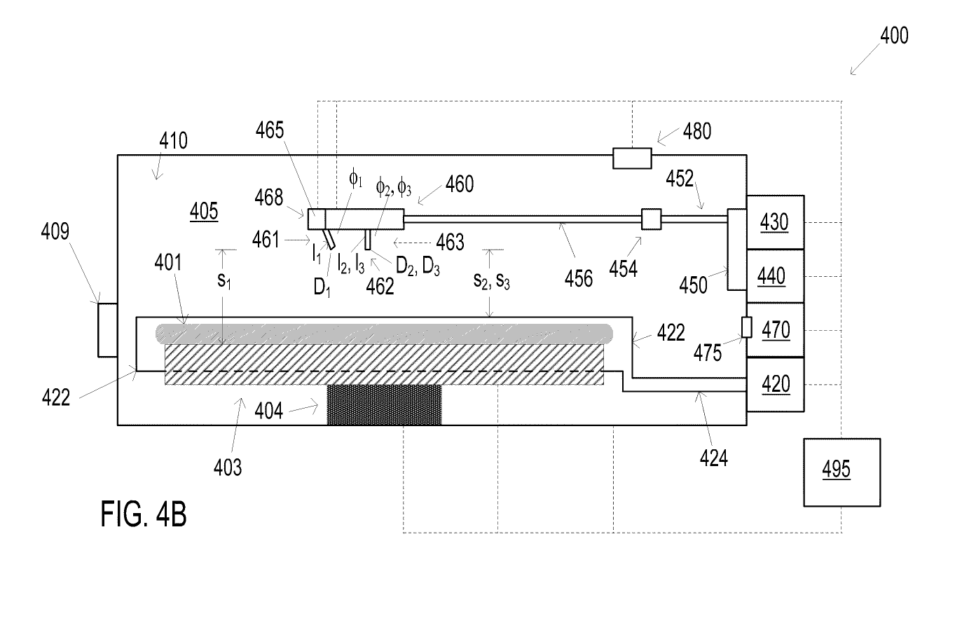

FIGS. 4a-4b show exemplary schematic views of a rinsing system in accordance with embodiments of the invention. In the illustrated embodiment, an exemplary rinsing system 400 is shown that comprises a processing chamber 410, a wafer table 403 for supporting a wafer 401, and a translation unit 404 coupled to the wafer table 403 and to the processing chamber 410. The wafer table 403 can include a vacuum system (not shown) for coupling the wafer 401 to the wafer table 403. The translation unit 404 can be used to align the wafer table 403 in one or more directions and can be used to rotate the wafer table. For example, revolution rates can vary from approximately 0 rpm to approximately 4,000 rpm; the revolution rate accuracy can vary from approximately +1 rpm to approximately −1 rpm; and the acceleration rates can vary from approximately 100 rpm/sec to approximately 50,000 rpm/sec.

The dispensing subsystem 460 can be coupled to the control subsystem 450 using one or more first supply elements 452, one or more coupling elements 454, and one or more second supply elements 456. For example, the first supply elements 452, the coupling elements 454, and second supply elements 456 can be configured as flexible arms. Dispensing subsystem 460 can comprise one or more rinse nozzle assemblies 461, one or more process gas nozzle assemblies 462, and one or more dispensing nozzle assemblies 463. The rinsing system 400 can include a fluid supply subsystem 430 and a gas supply subsystem 440 coupled to the processing chamber 410. The fluid supply subsystem 430 can be configured to provide processing fluids at the correct temperatures and flow rates when they are required. The gas supply subsystem 440 can be configured to provide processing gasses at the correct temperatures and flow rates when they are required. For example, processing gasses can include inert gasses, air, reactive gasses, and non-reactive gasses.

The dispensing subsystem 460 can have a length 466, a width 467, and a height 468 associated therewith. The length 466 can vary from approximately 5 mm to approximately 100 mm, the width 467 can vary from approximately 5 mm to approximately 50 mm, and the height 468 can vary from approximately 5 mm to approximately 20 mm.

In some embodiments, the dispensing subsystem 460 can comprise one or more rinse nozzle assemblies 461, one or more process gas nozzle assemblies 462, and one or more dispensing nozzle assemblies 463. Alternatively, a different number of nozzle assemblies may be used. The rinse nozzle assembly 461 can have a first length I₁ and a first angle φ₁ associated therewith; the process gas nozzle assembly 462 can have a length I₂, and an angle φ₂ associated therewith; and the dispensing nozzle assembly 463 can have a third length I₃, and a third angle φ₃ associated therewith. The first length I₁ can vary from approximately 5 mm to approximately 50 mm, and the first angle φ₁ can vary from approximately 10 degrees to approximately 110 degrees. The second length I₂ can vary from approximately 5 mm to approximately 50 mm, and the second angle φ₂ can vary from approximately 10 degrees to approximately 110 degrees. The third length I₃ can vary from approximately 5 mm to approximately 50 mm, and the third angle φ₃ can vary from approximately 10 degrees to approximately 110 degrees.

The rinse nozzle assembly 461 can comprise a first dispensing tip D₁ that can have an inside (orifice) diameter that can range from approximately 0.1 mm to approximately 2.0 mm and can have an outside diameter that can range from approximately 0.5 mm to approximately 5.0 mm. The process gas nozzle assembly 462 can comprise a second dispensing tip D₂ that can have an inside (orifice) diameter that can range from approximately 0.1 mm to approximately 2.0 mm and can have an outside diameter that can range from approximately 0.5 mm to approximately 5.0 mm. In addition, the dispensing nozzle assembly 463 can comprise a third dispensing tip D₃ that can have an inside (orifice) diameter that can range from approximately 0.1 mm to approximately 2.0 mm and can have an outside diameter that can range from approximately 0.5 mm to approximately 5.0 mm.

In some embodiments, a first separation distance s₁ can established between the first dispensing tip D₁ and the top surface of the wafer table 403, and the first separation distance s₁ can range from approximately 2 mm to approximately 25 mm; a second separation distance s₂ can established between the second dispensing tip D₂ and the top surface of the wafer table 403, and the second separation distance s₂ can range from approximately 2 mm to approximately 25 mm; and a third separation distance s₃ can established between the third dispensing tip D₃ and the top surface of the wafer table 403, and the third separation distance s₃ can range from approximately 2 mm to approximately 25 mm.

In other embodiments, one or more of the separation distances (s₁, s₂, s₃) can be established using the top surface of the wafer 401.

The dimensions can be dependent upon the wafer type, the type of residue being removed, the processing chemistries being used, and the rinsing solutions being used. In addition, one or more of the separation distances (s₁, s₂, s₃) can be changed during processing as the dispensing subsystem 460 is moved with respect to the wafer. For example, the minimum separation distances (s₁, s₂, s₃) can be dependent upon the wafer type, the feature type, the wafer curvature, the residue being removed, the amount of residue, the location of the residue, and/or the rinsing solutions being used.

One or more of the nozzle assemblies (461, 462, and 463) can be cylindrical, rectangular, and/or tapered. Alternatively, other shapes and angles may be used.

The processing chamber 410 can include one or more exhaust ports 475 that are coupled to the process space 405 and to one or more exhaust systems 470. In addition, an exhaust port 475 may comprise one or more valves (not shown) and/or one or more exhaust sensors (not shown). Those skilled in the art will recognize that the one or more valves may be used for controlling flow in and/or out of the process space 405, and one or more exhaust sensors may be used for determining the processing state for the processing chamber 410 in the rinsing system 400. For example, one or more of the exhaust ports 475 may be coupled to an exhaust system 470 using flexible hoses/tubes/pipes/conduits (not shown). In some embodiments, the exhaust ports 475 and the exhaust systems 470 can be used to exhaust rinsing, cleaning, and/or other processing gasses that must be removed from the process space 405. In other embodiments, the exhaust ports 475 and the exhaust systems 470 can be used to control pressure within the process space 405.

Processing chamber 410 can include a wafer transfer port 409 that can be opened during wafer transfer procedures and closed during wafer processing.

The rinsing system 400 can comprise one or more recovery systems 420, and the recovery system 420 can be configured to analyze, filter, re-use, and/or remove one or more processing fluids. For example, some rinsing and/or cleaning components (solvents) may be re-used. In addition, the rinsing system 400 can comprise one or more fluid capture systems 422 and supply line 424 that can be coupled to the recovery system 420.

Still referring to FIG. 4, the rinsing system 400 can include a controller 495 that can be coupled to the wafer table 403, the translation unit 404, the wafer transfer port 409, the processing chamber 410, the recovery system 420, the fluid supply subsystem 430, the gas supply system 440, the control subsystem 450, the coupling elements 454, and the dispensing subsystem 460. Alternatively, other configurations may be used.

In various embodiments, the rinsing system 400 can include one or more monitoring systems 480 coupled to the process space 405, and the monitoring systems 480 can be used to determine wafer size, wafer curvature, edge beads, separation distances, processing states, positions, thicknesses, temperatures, pressures, flow rates, chemistries, rotation rates, acceleration rates, residues, or particles, or any combination thereof. In additional embodiments, the dispensing subsystem 460 can include one or more sensors 465, and the sensors 465 can be used to determine separation distances, processing states, positions, thicknesses, temperatures, flow rates, chemistries, rotation rates, acceleration rates, residues, or particles, or any combination thereof.

In addition, the rinsing system 400 can include a number of cleaning stations 490, and, individual cleaning stations 490 can be provided for the rinse nozzle assemblies 461, for the process gas nozzle assemblies 462, and/or the dispensing nozzle assemblies 463. The nozzle assemblies (461, 462, and 463) can be positioned in the cleaning stations 490 when the nozzle assemblies (461, 462, and 463) are not being used or during a self-cleaning procedure. For example, the cleaning stations can include cleaning fluids that are selected to clean the nozzle assemblies (461, 462, and 463).

In some rinsing procedures, pure water can be used. In various cleaning procedures, Propylene Glycol Monomethyl Ether Acetate can be used as cleaning fluids or rinsing agent. In other removal procedures, other solvents or blends of solvents or liquids can be used based on the type and amount of undesired film. In addition, cleaning fluids or rinsing agents can include the following as single materials or blends: N-Butyl Acetate, Cyclohexanone, Ethyl Lactate, Acetone, Isopropyl alcohol, 4-methyl 2-Pentanone, Gamma Butyl Lactone. In other cleaning procedures, water or diluted HF or diluted sulfuric acid/hydrogen peroxide can be used for removing polymer films and/or edge-bead material.

In alternate examples, the rinsing system 400 and/or the dispensing subsystem 460 may include electrical, resistance, thermoelectric, and/or optical heating elements (not shown). In other examples, Nitrogen or any other gas may be provided through one or more of the nozzle assemblies (461, 462) in the dispensing subsystem 460.

In this invention, a novel method of controlling the movement of the dispensing subsystem 460 during wafer rotation is used to reduce the quantity of droplets left after rinse processing. In addition, the control of the water film during rinse improves the effectiveness of removing defects deposited on the wafer surface during develop processing.

When wafer-rinsing procedures are established, real-time and historical data can be used to obtain rinsing recipes that have a minimum number of real-time control variables. In some embodiments, the real-time control variables can include the nozzle scan speed and the wafer rotation rate (Rotations per Minute, or similar).

Generally, within a rinse recipe, an increase in wafer rotation rate and/or a reduction in nozzle scan speed will result in reduced defect formation.

In this invention, a formula is derived that combines nozzle scan speed and wafer rotation rate, such that a distance the nozzle travels during one rotation is calculated. The nozzle movement per rotation (hereafter “NMpR”) can be calculated at all radial positions for any combination of nozzle scan speed and wafer rotation rate.

Experimental results show that for a given wafer condition (resist material, exposure pattern, etc.) and rinse recipe (nozzle scan speed and wafer rotation rate), calculating NMpR at the specific radius at which defects transition from low to high density allows prediction of a corresponding radius of defect transition for a different rinse recipe.

By utilizing the knowledge gained through experiment and calculation of NMpR at the defect transition radius, it is possible to predict a maximum NMpR below which no defect formation results. Knowing the maximum NMpR below which no defect results allows selection of recipe conditions to maintain nozzle scan speed and wafer rotation rate such that no defects are formed.

Furthermore, it is possible to optimize recipe throughput, by reducing the total recipe time, while forming no defects. Recipe throughput optimization is achieved by changing the nozzle scan speed at a specific radius, identified through NMpR calculation and experiment, such that if nozzle scan speed was maintained beyond this radius defect formation would occur. Ideally, selecting a wafer rotation rate that allows maintaining a high-velocity nozzle scan speed as long as possible will achieve the greatest reduction in throughput.

Furthermore, it is possible to further optimize recipe throughput by calculating a continuous change in wafer rotation rate and a continuous change in nozzle scan speed to maintain a constant NMpR below the transition value.

In some embodiments, a variable wafer rotation and a variable nozzle scan speed can be used during rinse processing. The method of identifying at what optimal value wafer rotation and nozzle scan speed can be employed, by utilizing the NMpR calculation method, allows a reduction in setup time and a method of improving throughput.

One improvement on this basic rinse process was the addition of surfactant products to the rinse water supply. Surfactinated water rinse processing improves the wettability of the substrate, and therefore allows a cleaner spin-dry process and leaves fewer residue droplets.

Another improvement on this process was TEL's so-called PDR (Physical Defect Reduction) strategy. In this process, the rinse nozzle is not fixed above the wafer center, but instead begins water dispense at the center, then, while continuing to dispense water, moves along a radial axis towards the wafer edge. An application of Nitrogen gas may or may not be applied while the rinse nozzle is in the wafer center position to enhance the formation of a dry center area. During processing, nozzle scan speed is constant from center to edge.

Another improvement on this process was TEL's in-development ADR (Advanced Defect Reduction) strategy. In this process, the rinse nozzle is placed over the wafer center at water dispense start. Application of Nitrogen gas and high-velocity rotation during center-dispense enhance the formation of a dry center spot. Once the dry center spot is formed, the rinse nozzle scans from center to edge. At the same time as nozzle scan, the wafer rotation is reduced from high RPM to low RPM by maintaining a constant angular velocity beneath the nozzle. During processing, nozzle scan speed is constant from center to edge.

One advantage of the current invention is the utilization of targeted experimental design to determine the NMpR transition point from low to high defects. The limited number of experiments will reduce the time and materials cost of setting up ADR process. Another advantage is the further reduction of defects in the rinse process. Still another advantage is throughput optimization of the rinse process.

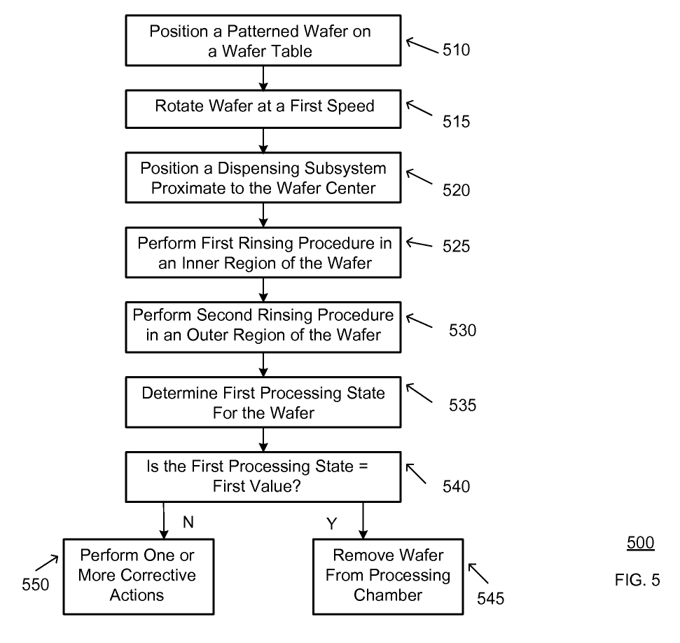

FIG. 5 illustrates a simplified flow diagram for a method for using a rinsing system according to embodiments of the invention. After a patterned photoresist layer or ARC layer is developed, a rinsing system can be used to remove developer material, photoresist residue, antireflective residue or other polymer residues from the top side (top surfaces) and/or the backside (edge surfaces) of the wafer.

In some embodiments, Design of Experiment (DOE) techniques can be used to optimize the rinsing procedure. Some DOE results have shown that when a first set of processing variables are used (resist material, resist thickness, wafer material, exposure data, focus data, dose data, contact angles, necking distances, nozzle scan speed, wafer rotation rate, flow rates, dispense volume, velocity profiles, shear rates, spin-off profiles, etc.), different defect density patterns can be produced. In some examples, one or more defect radii can be identified at which the defect density transitions from lower density to a higher density, and the methods of the present invention can be used to predict the defect radii associated with different rinse recipes. Calibration factors can be established using measured and simulation data for different defect patterns, different wafers, different rinse recipes, and/or different defect radii. When the calibration factors are calculated at the specific radii at which defects transition from a lower density to a higher density, these calibration factors can be used to predict the defect radii for different and/or modified rinse recipes.

The inventor has determined that each set of processing variables associated with the rinsing procedure can establish a different set of defect transition points. The inventor has used DOE techniques to develop simulation models that are based on different sets of processing variables associated with the rinsing procedure, and the simulation models have been used to predict the defect transition points for various rinsing procedures. In various examples, the processing variables can include: defect data, resist material data, resist thickness data, wafer data, exposure data, focus data, dose data, contact angle data, necking distance data, nozzle scan speed data, wafer rotation rate data, flow rate data, dispense volume data, velocity profile data, shear rate data, spin-off profile data, nozzle diameter data, NMpR data, nozzle length data, or nozzle separation data, or any combination thereof.

Since the number of processing variables associated with a rinsing procedure can be large, the inventor has developed simulation models that use targeted experimental design data to determine the transition point from low to high defects. The inventor believes that because the simulation models are based on a limited number of experiments, these simulation models will reduce the time and materials cost of setting up advanced defect reduction (ADR) processes. In some examples, an NMpR transition point can be identified for each implementation of ADR processes prior to optimizing the rinse recipe.

In some embodiments, the constant angular velocity (V_{ang}) can be calculated by specifying the desired final RPM when the nozzle is at the wafer edge, as well as the total diameter of the wafer. See Eq. 1. Next, the NMpR can be calculated as a function of the radial position (Radius), the nozzle scan speed, and the constant angular velocity (V_{ang}).

$$\begin{matrix}{V}_{ang} = Final R P M \cdot π \cdot {Diameter}_{wafer} & Eq . 1 \\ N M p R = \frac{2 π \cdot Radius}{{V}_{ang}} \cdot Nozzle Scan Speed & Eq . 2\end{matrix}$$

When a constant angular velocity and a constant scan speed are used in a rinsing recipe, the distance the nozzle travels per revolution is small when the nozzle is positioned close to the wafer center, but the distance the nozzle travels per revolution becomes larger as the nozzle is moved close to the wafer edge.

When a limited set of DOE data was collected using a test reticle design and a limited set of processing variables, the defect radius and the defect count data was determined to be dependent upon the nozzle scan speed and Final RPM. The limited set of processing variables included the a Chemically-Amplified (CA) resist data, nozzle scan speed, exposure data for the CA resist, reticle pattern data, final RPM data, defect radius data, and defect count data. When the NMpR was examined for streak data, the minimum NMpR was determined to be approximately 0.25 mm and the maximum NMpR was determined to be approximately 0.45 mm.

When the NMpR limits are determined using structured DOE data, then a calibration factor and a nozzle velocity can be calculated as shown in Eq. 3 and Eq. 4. respectively. The NMpR can be a function of the wafer rotation rate and nozzle scan speed, and the wafer rotation rate can be defined as a constant angular velocity (set at wafer edge).

$$\begin{matrix}CalibrationFactor = 60 / N M p R & Eq . 3 \\ {Velocity}_{nozzle} = Final R P M / CalibrationFactor & Eq . 4\end{matrix}$$

When the NMpR data varies between approximately 0.25 mm and 0.45 mm, the calibration factor can vary between approximately 130 and approximately 240. In other cases, the calibration factor can be determined using a simulation model based on a customer's processing recipe, and the NMpR value can be determined using the simulated calibration factor. When an optimum calibration factor is determined, the process engineers at the customer site can increase the calibration factor to decrease the number of defects or decrease the calibration factor to increase throughput.

Referring back to 510 in FIG. 5, a patterned wafer can be positioned on a wafer table, and vacuum techniques can be used to fix the wafer to the wafer table. Alternatively, an un-patterned wafer may be used. In some processing sequences, an alignment procedure can be performed using a notch in the wafer.

In 515, the patterned wafer and the wafer table can be rotated in a processing chamber at a first rotation rate, and the first rotation rate can be a first constant angular velocity during a first time. In some processing sequences, a first wafer position can be determined using a notch in the wafer. The patterned wafer can have residue material in and/or on one or more features on the top surfaces, and the recipe data and/or simulation data can be used to determine the type of residue material and location of the residue material. Alternatively, the rinsing system can be used to determine the type of residue material and location of the residue material using monitoring systems 480. For example, the wafer and the wafer table can be at substantially the same temperature, and the wafer table temperature can be used to control the wafer temperature.

In some embodiments, the angular velocity V_{ang} data can be calculated using Eq. 1, the NMpR data can be calculated using Eq. 2, the calibration factor can be calculated using Eq. 3, and the nozzle velocity can be calculated using Eq. 4. The first angular velocity V_{ang} data can range from approximately 10 revolutions per minute (rpm) to approximately 2500 revolutions per minute (rpm). The NMpR data can range from approximately 0.25 mm to approximately 0.45 mm. The calibration factor can range from approximately 100 to approximately 400, and the calibration factor can be different for each manufacturing environment. The nozzle velocity can vary from approximately 1 mm/s to approximately 100 mm/s.

In 520, a dispensing subsystem can be positioned proximate to the center of the wafer. In some embodiments, the dispensing subsystem can include a rinsing nozzle assembly, and the rinsing nozzle assembly can be positioned at a first location proximate to the center of the wafer during a first time, and the first location can be determined using the recipe data and/or simulation data.

The dispensing subsystem 460 can be configured to provide a first set of rinsing fluids and/or gasses to a rinsing space 464 proximate the wafer surface using one or more of the rinse nozzle assemblies 461, or one or more of the process gas nozzle assemblies 462, or one or more of the dispensing nozzle assemblies 463, or any combination thereof. In addition, the dispensing subsystem 460 can be scanned across the wafer surface from a point proximate the wafer center to a point proximate the edge of the wafer during a rinsing process. In some alternate procedures, the dispensing subsystem 460 can provide heated rinsing fluids and/or gasses to the wafer surface. In other alternate procedures, the dispensing subsystem 460 can provide cooled rinsing fluids and/or gasses to the wafer surface.

The inventor has determined that each set of processing variables associated with the rinsing procedure can establish a different set of defect transition points. The inventor has used DOE techniques to develop simulation models that are based on different sets of processing variables associated with the rinsing procedure, and the simulation models have been used to predict the defect transition points for various rinsing procedures. In various examples, the processing variables can include: defect data, resist material data, resist thickness data, wafer data, exposure data, focus data, dose data, contact angle data, necking distance data, nozzle scan speed data, wafer rotation rate data, flow rate data, dispense volume data, velocity profile data, shear rate data, spin-off profile data, nozzle diameter data, NMpR data, nozzle length data, or nozzle separation data, or any combination thereof.

Since the number of processing variables associated with a rinsing procedure can be large, the inventor has developed simulation models that use targeted experimental design data to determine the transition point from low to high defects. The inventor believes that because the simulation models are based on a limited number of experiments, these simulation models will reduce the time and materials cost of setting up automatic defect reduction (ADR) processes. In some examples, an NMpR transition point can be identified for each implementation of the ADR processes prior to optimizing the rinse recipe.

In 525, first rinsing procedures can be performed. In some embodiments, the first rinsing procedures can be performed in one or more inner regions on the wafer surface. Alternatively, other regions may be used.

In some embodiments, the angular velocity V_{ang} data can be calculated using Eq. 1, the NMpR data can be calculated using Eq. 2, the calibration factor can be calculated using Eq. 3, and the nozzle velocity can be calculated using Eq. 4. The first angular velocity V_{ang} data can range from approximately 10 revolutions per minute (rpms) to approximately 2500 revolutions per minute (rpms). The NMpR data can range from approximately 0.25 mm to approximately 0.45 mm. The calibration factor can range from approximately 100 to approximately 400, and the calibration factor can be different for each manufacturing environment. The nozzle velocity can vary from approximately 1 mm/s to approximately 200 mm/s.

In some examples, one or more of the rinse nozzle assemblies 461 can be used to provide one or more rinsing fluids and/or gasses in one or more directed flows onto the wafer's top surface during the first rinsing procedure. In other examples, one or more of the rinse nozzle assemblies 461 can also be used to provide one or more rinsing fluids and/or gasses in one or more directed flows onto the wafer's edge during the first rinsing procedure. For example, the residue can be different in different regions on the top surface of the wafer, and the residue at the wafer's edge can also be different.

During the first rinsing procedures, the rinsing fluids, the rinsing gasses, the rinsing agents, the rotation rates, the flow rates, the position and/or scan speed of the dispensing subsystem 460, and dispensing times can be determined by a process recipe or a simulation model. In addition, the rinsing fluids, the rinsing gasses, the rinsing agents, the rotation rates, the flow rates, the position and/or scan speed of the dispensing subsystem 460, and dispensing times can change during the first rinsing procedures. For example, the rinsing fluids, the rinsing gasses, the rinsing agents, the rotation rates, the flow rates, and/or the flow directions can change as the position and/or scan speed of the dispensing subsystem 460 is changed during the first rinsing procedure. In various examples, the rinsing fluids, the rinsing gasses, the rinsing agents, the rotation rates, the flow rates, and/or the scan speed of the dispensing subsystem 460 can change as the dispensing subsystem 460 is moved towards the wafer edge, or as the dispensing subsystem 460 is positioned near the wafer edge, or as the dispensing subsystem 460 is moved away from the wafer edge, or any combination thereof during the first rinsing procedure.

The rinsing system 400 can comprise one or more recovery systems 420, and the recovery system 420 can be configured to analyze, filter, re-use, and/or remove one or more processing fluids during the first rinsing procedure. For example, a first set of residual rinsing fluids and/or gasses can be removed from one or more features on the top surface of the wafer during the first rinsing procedure, and the first set of residual rinsing fluids and/or gasses can comprise photoresist material, rinsing agents, and/or developer residue.

In 530, second rinsing procedures can be performed. In some embodiments, the second rinsing procedures can be performed in one or more outer regions on the wafer surface. Alternatively, other regions may be used.

In some examples, one or more of the rinse nozzle assemblies 461 can be used to provide one or more second rinsing fluids and/or gasses in one or more directed flows onto the wafer's top surface during the second rinsing procedure. In other examples, one or more of the rinse nozzle assemblies 461 can also be used to provide one or more rinsing fluids and/or gasses in one or more directed flows onto the wafer's edge during the second rinsing procedure. For example, the residue can be different in different regions on the top surface of the wafer, and the residue at the wafer's edge can also be different.

During the second rinsing procedures, the rinsing fluids, the rinsing gasses, the rinsing agents, the rotation rates, the flow rates, the position and/or scan speed of the dispensing subsystem 460, and dispensing times can be determined by a process recipe or a simulation model. In addition, the rinsing fluids, the rinsing gasses, the rinsing agents, the rotation rates, the flow rates, the position and/or scan speed of the dispensing subsystem 460, and dispensing times can change during the second rinsing procedures. For example, the rinsing fluids, the rinsing gasses, the rinsing agents, the rotation rates, the flow rates, and/or the flow directions can change as the position and/or scan speed of the dispensing subsystem 460 is changed during the second rinsing procedure. In various examples, the rinsing fluids, the rinsing gasses, the rinsing agents, the rotation rates, the flow rates, and/or the scan speed of the dispensing subsystem 460 can change as the dispensing subsystem 460 is moved towards the wafer edge, or as the dispensing subsystem 460 is positioned near the wafer edge, or as the dispensing subsystem 460 is moved away from the wafer edge, or any combination thereof during the second rinsing procedure.

The rinsing system 400 can comprise one or more recovery systems 420, and the recovery system 420 can be configured to analyze, filter, re-use, and/or remove one or more processing fluids during the second rinsing procedure. For example, a second set of residual rinsing fluids and/or gasses can be removed from one or more features on the top surface of the wafer during the second rinsing procedure, and the second set of residual rinsing fluids and/or gasses can comprise photoresist material, rinsing agents, and/or developer residue.

In some alternate rinsing sequences, one or more drying procedures may be performed. When drying procedures are performed, the dispensing subsystem 460 can be used to provide one or more drying gasses in one or more additional directed flows onto the wafer surfaces. During a drying procedure, the drying gasses, the rotation rates, the flow rates, the position and/or scan speed of the dispensing subsystem 460, and processing times can be determined by a process recipe and/or simulation model.

In 535, a first processing state can be determined for patterned wafer, and the processing state can be determined using historical data and/or real-time data. The historical data and/or real-time data can include risk data, confidence data, process data, predicted data, measured data, defect data, simulation data, verified data, or library data, or any combination thereof.

In some embodiments, a first processing state for the patterned wafer can be determined using residue data, and the first processing state can be a first value when one or more residue streaks are present on the wafer surface and can be a second value when one or more residue streaks are not present on the wafer surface. In other embodiments, the first processing state for the patterned wafer can be determined using defect data, particle count data, particle size data, particle location data, or bridging data, or any combination thereof.

In various embodiments, the processing state data, first measurement data, the confidence data, and/or risk data from one or more rinsed wafers can be examined to determine if additional wafers should be processed. For example, one or more send-ahead substrates can be selected for processing before an entire lot is processed.

In some examples, individual and/or total confidence values for the rinsed substrate can be compared to individual and/or total confidence limits. The processing of a set of substrates can continue, if one or more of the confidence limits are met, or corrective actions can be applied if one or more of the confidence limits are not met. Corrective actions can include establishing confidence values for one or more additional substrates in the set of substrates, comparing the confidence values for one or more of the additional substrates to additional confidence limits; and either continuing to process the set of substrates, if one or more of the additional confidence limits are met, or stopping the processing, if one or more of the additional confidence limits are not met.

In other examples, individual and/or total risk values for the substrate can be compared to individual and/or total risk limits. The processing of a set of substrates can continue, if one or more of the risk limits are met, or corrective actions can be applied if one or more of the risk limits are not met. Corrective actions can include establishing risk values for one or more additional substrates in the set of substrates, comparing the risk values for one or more of the additional substrates to additional risk limits; and either continuing to process the set of substrates, if one or more of the additional risk limits are met, or stopping the processing, if one or more of the additional risk limits are not met.

In 540, a query can be performed to determine if the first processing state is equal to a first value and substantially all of the residue material has been removed. When the first processing state is equal to a first value, procedure 500 can branch to 545. When the first processing state is not equal to the first value, procedure 500 can branch to 550. In various embodiments, a first processing state can be determined for the wafer using data from a recovery system 420 the first processing state being determined using a removal amount; the wafer can be removed from the processing chamber if the first processing state is a first value (total removal); and one or more corrective actions can be performed if the first processing state is a second value (only partial removal).

In 545, the rinsed wafer can be removed from the processing chamber 410 in the rinsing system 400.

In 550, one or more corrective actions can be performed. Corrective actions can include cleaning procedures, rinsing procedures, drying procedures, measuring procedures, inspection procedures, or storage procedures, or any combination thereof. For example, the wafer can be re-processed using the same or a different rinsing procedure and/or rinsing system.

Some rinsing sequences can include one or more procedures for determining a first wafer position when the wafer is rotated at a first rotation rate for a first time, and the positioning of the dispensing subsystem 460 can be determined using the first wafer position during the first time. For example, a monitoring system 480 and/or a sensor 465 in the dispensing subsystem 460 can be configured and used to determine wafer position, to position the dispensing subsystem 460, to monitor the rinsing space 464, and to monitor the top surface of the wafer 401. For example, the residue material can also include polymer residue, photoresist material, low-k material, or ultra-low-k material, or combination thereof.

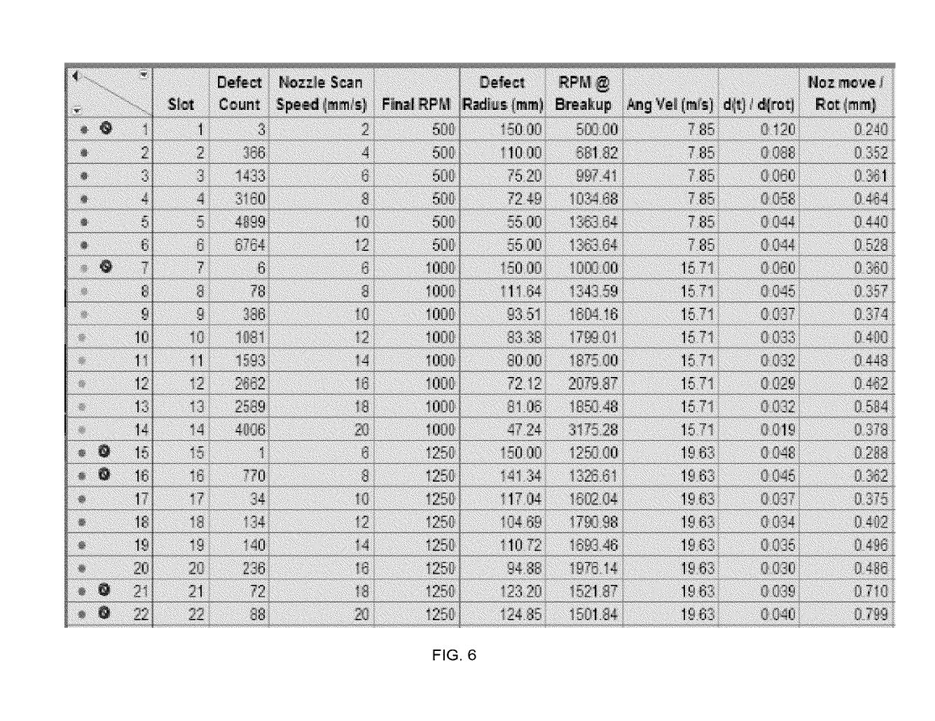

FIG. 6 illustrates an exemplary DOE data table in accordance with embodiments of the invention. An exemplary data table from a set of DOE procedures is shown in FIG. 6 and the exemplary data in the data table can include slot data, defect count data, nozzle scan speed data (mm/s), final RPM data, maximum RPM data, minimum RPM data, variable RPM data, acceleration data, defect radius data (mm), RPM breakup data, angular velocity data (mm/s), [d(t)/d(rot)] data, and (nozzle move/rot (mm)) data. Additional DOE data can include photoresist data that can include material data, thickness data, uniformity data, optical data, CD data, SWA data, PEB data, or PAB data, or any combination thereof. In addition, the DOE data can include developing data, cleaning data, drying data, chamber matching data, wafer thickness data, or wafer curvature data, or any combination thereof.

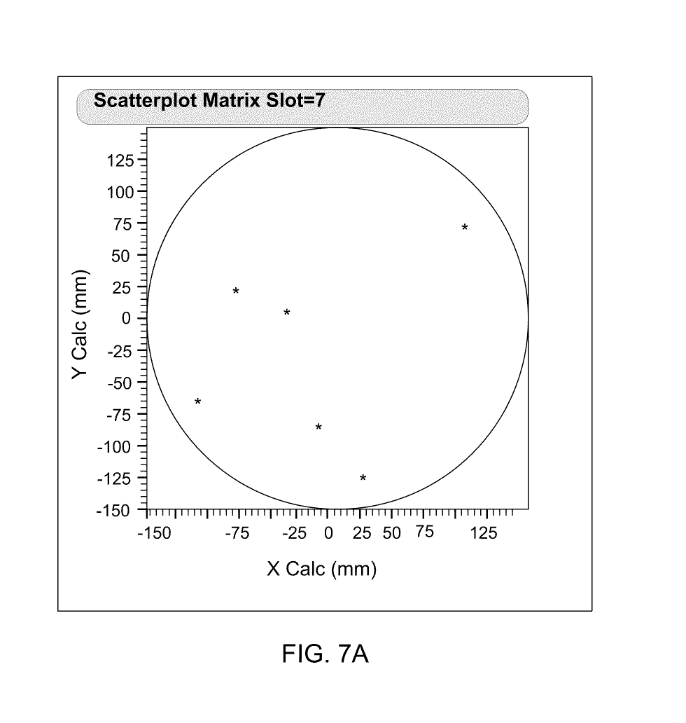

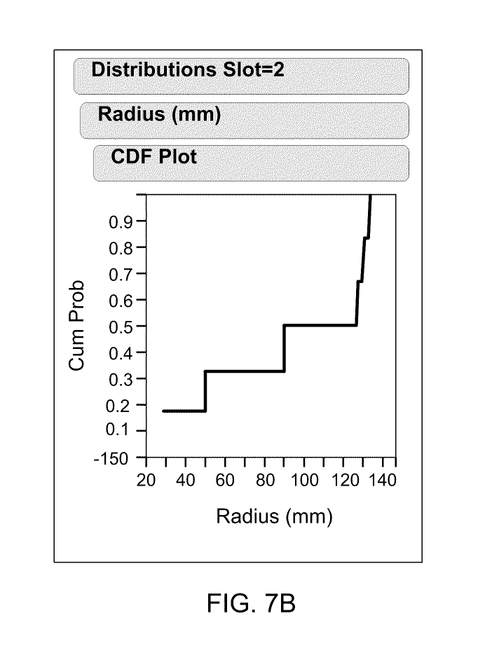

FIGS. 7A and 7B illustrate exemplary DOE data in accordance with embodiments of the invention. Exemplary scatter plot matrix data for the “slot 7” data set in FIG. 6 is shown in FIG. 7A, and an exemplary cumulative distribution function (CDF) plot data for the “slot 7” data set in FIG. 6 is shown in FIG. 7B. In some embodiments, the exemplary data shown in FIG. 7A and FIG. 7B can be used to identify a successful rinsing procedure. For example, the number of particles and the position of the particles may be within the limits established for a successful rinsing procedure. In some examples, filtering functions may be used to remove some of the particles.

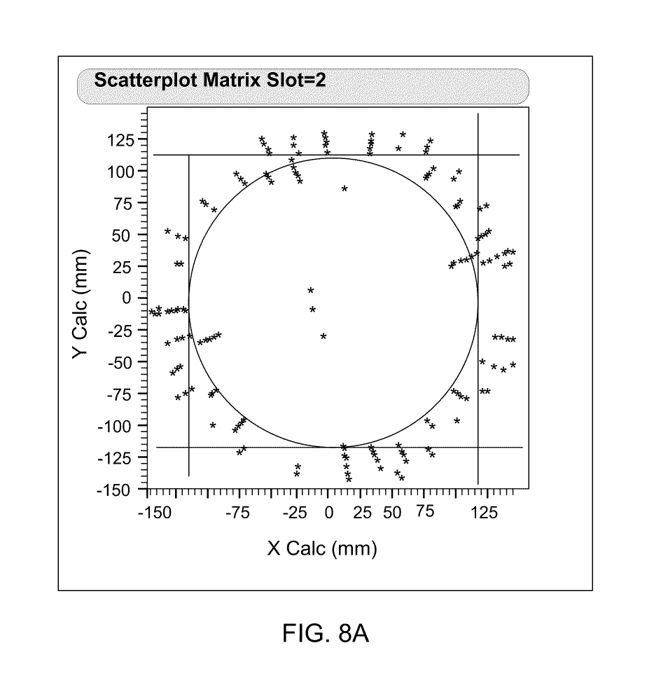

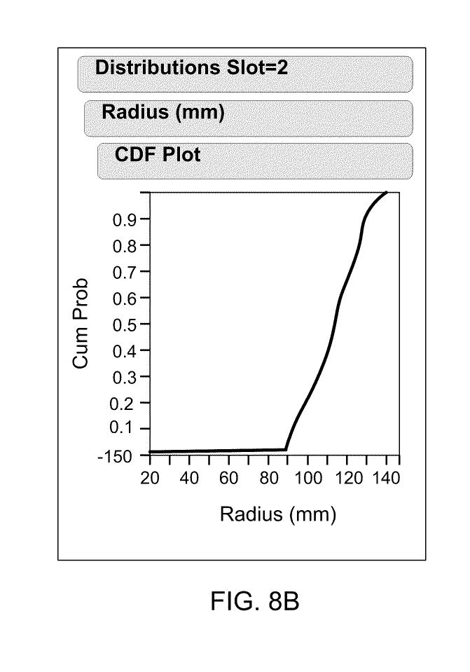

FIGS. 8A and 8B illustrate additional exemplary DOE data in accordance with embodiments of the invention. Exemplary scatter plot matrix data for the “slot 2” data set in FIG. 6 is shown in FIG. 8A, and an exemplary cumulative distribution function (CDF) plot data for the “slot 2” data set in FIG. 6 is shown in FIG. 8B. In some embodiments, the exemplary data shown in FIG. 8A and FIG. 8B can be used to identify an unsuccessful rinsing procedure. For example, the number of particles and the position of the particles may not be within the limits established for a successful rinsing procedure. In some examples, an unsuccessful rinsing procedure may be identified using “streak data” such as shown in FIG. 8A. In other, examples, filtered “streak data”, or averaged “streak data”, or cumulative “streak data” may be used. In still other examples, particle data from isolated and/or dense patterns on the wafer may be used to identify the number of particles, the position of the particles, and the quality of the rinsing procedures.

FIG. 9 illustrates exemplary defect radius data in accordance with embodiments of the invention. An exemplary graph 900 is shown in FIG. 9, and the illustrated graph 900 shows defect data for three exemplary data sets (901, 902, and 903). In the first data set 901, the Final RPM is equal to 500 rpm, the Min (nozzle scan speed is equal to 2 mm/s, and the Max (nozzle scan speed is equal to 12 mm/s. In the second data set 902, the Final RPM is equal to 1000 rpm, the Min (nozzle scan speed is equal to 6 mm/s, and the Max (nozzle scan speed is equal to 20 mm/s. In the third data set 903, the Final RPM is equal to 1250 rpm, the Min (nozzle scan speed is equal to 8 mm/s, and the Max (nozzle scan speed is equal to 20 mm/s.

In addition, a mean value line 910 is plotted, a (1-sigma) value line 920 is shown, and a (2-sigma) value line 930 is shown. In some cases, the minimum bound of the nozzle movement per rotation (NMPR) can be established at approximately 1-sigma below the mean value. In addition, the (2-sigma) value line 930 can be used for calculating the NMpR threshold. The (1-sigma) value line 920 is shown at approximately 0.36 mm, and the (2-sigma) value line 930 is shown at approximately 0.29 mm.

In some embodiments, the exemplary data shown in FIG. 9 can be used to identify limits that can be used to establish a successful rinsing procedure. For example, the number of particles and the position of the particles shown in FIG. 9 may be within the limits established for a successful rinsing procedure. In some examples, the calculated NMpR values can be different from those shown in FIG. 9. The present invention provides rinsing models that can use chamber data, defect count data, nozzle scan speed data (mm/s), final RPM data, maximum RPM data, minimum RPM data, variable RPM data, acceleration data, defect radius data (mm), RPM breakup data, angular velocity data (mm/s), [d(t)/d(rot)] data, and (nozzle move/rot (mm)) data. In addition, the rinsing models can use photoresist data that can include material data, thickness data, uniformity data, optical data, CD data, SWA data, PEB data, or PAB data, or any combination thereof. Furthermore, the rinsing models can use developing data, cleaning data, drying data, chamber matching data, wafer thickness data, or wafer curvature data, or any combination thereof.

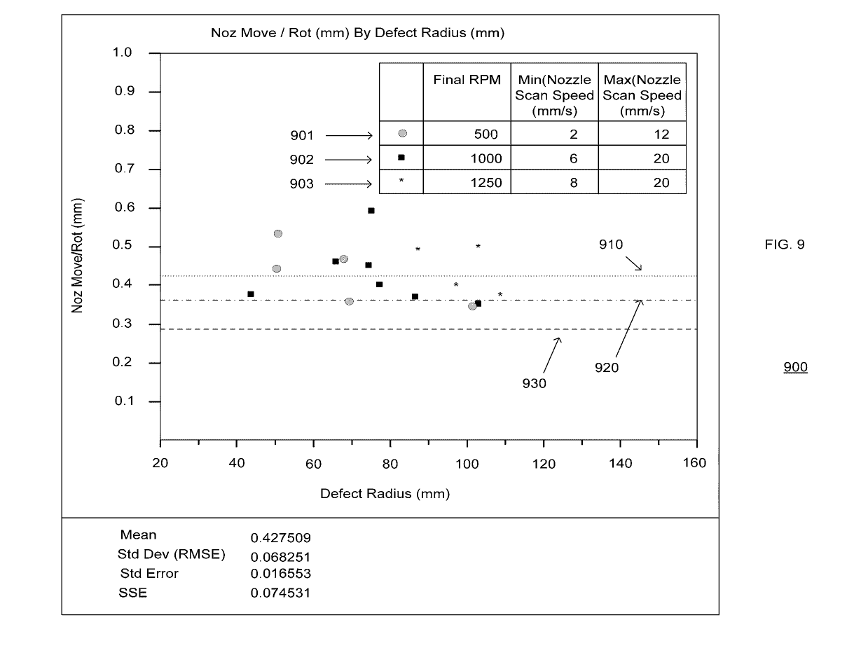

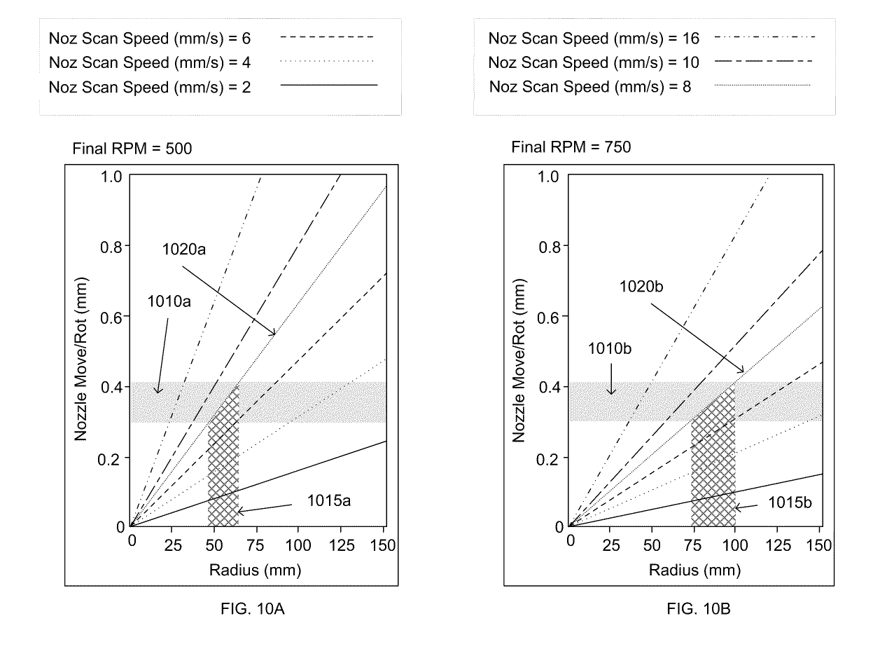

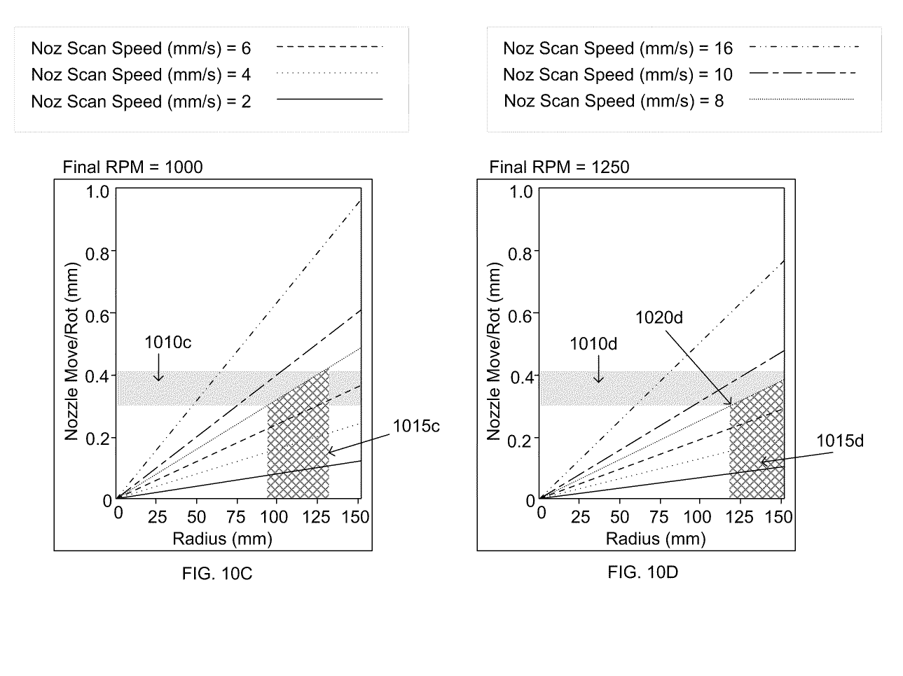

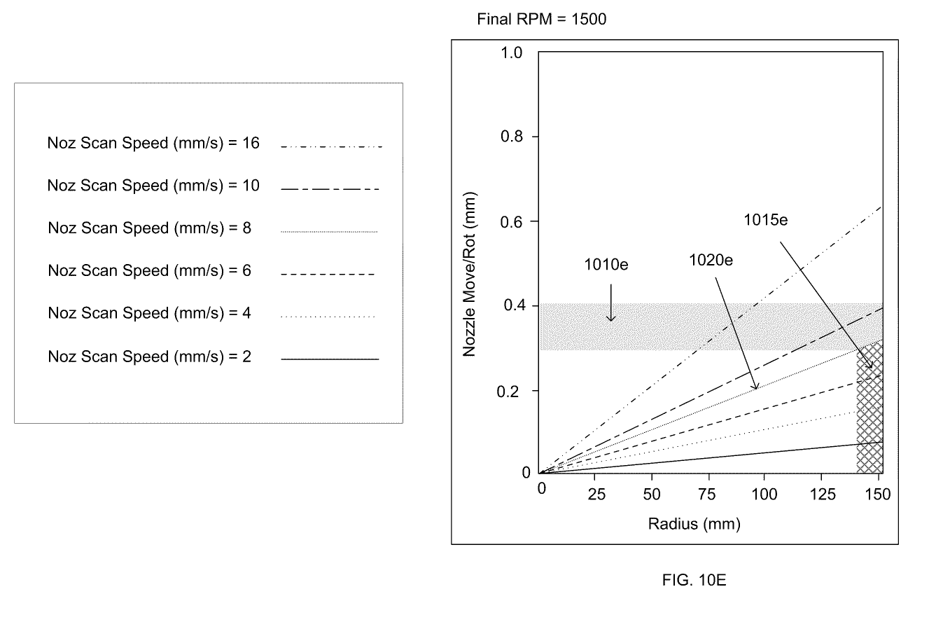

FIGS. 10A-10E illustrate exemplary nozzle scan speed data in accordance with embodiments of the invention. A first set of exemplary graphs are shown in FIG. 10A, that show simulated data [(Nozzle Move/Rot) versus (wafer radius)] for six different nozzle scan speeds (2 mm/s, 4 mm/s, 6 mm/s, 8 mm/s, 10 mm/s, and 16 mm/s) when the Final RPM is held constant at 500 rpm. A limit range 1010a is shown for the [Nozzle Move/Rot (mm)] that can range from approximately 0.29 mm to approximately 0.42 mm. In addition, a predicted defect radius range 1015a is shown for the 8 mm/s scan rate (1020a) that can range from approximately 47 mm to approximately 64 mm.

A second set of exemplary graphs are shown in FIG. 10B, that show simulated data [(Nozzle Move/Rot) versus (wafer radius)] for six different nozzle scan speeds (2 mm/s, 4 mm/s, 6 mm/s, 8 mm/s, 10 mm/s, and 16 mm/s) when the Final RPM is held constant at 750 rpm. A limit range 1010b is shown for the [Nozzle Move/Rot (mm)] that can range from approximately 0.29 mm to approximately 0.42 mm. In addition, a predicted defect radius range 1015b is shown for the 8 mm/s scan rate (1020b) that can range from approximately 74 mm to approximately 100 mm.

A third set of exemplary graphs are shown in FIG. 10C, that show simulated data [(Nozzle Move/Rot) versus (wafer radius)] for six different nozzle scan speeds (2 mm/s, 4 mm/s, 6 mm/s, 8 mm/s, 10 mm/s, and 16 mm/s) when the Final RPM is held constant at 1000 rpm. A limit range 1010c is shown for the [Nozzle Move/Rot (mm)] that can range from approximately 0.29 mm to approximately 0.42 mm. In addition, a predicted defect radius range 1015c is shown for the 8 mm/s scan rate (1020c) that can range from approximately 95 mm to approximately 128 mm.

A fourth set of exemplary graphs are shown in FIG. 10D, that show simulated data [(Nozzle Move/Rot) versus (wafer radius)] for six different nozzle scan speeds (2 mm/s, 4 mm/s, 6 mm/s, 8 mm/s, 10 mm/s, and 16 mm/s) when the Final RPM is held constant at 1250 rpm. A limit range 1010d is shown for the [Nozzle Move/Rot (mm)] that can range from approximately 0.29 mm to approximately 0.42 mm. In addition, a predicted defect radius range 1015d is shown for the 8 mm/s scan rate (1020d) that can range from approximately 143 mm to a value greater than approximately 150 mm.

A fifth set of exemplary graphs are shown in FIG. 10E, that show simulated data [(Nozzle Move/Rot) versus (wafer radius)] for six different nozzle scan speeds (2 mm/s, 4 mm/s, 6 mm/s, 8 mm/s, 10 mm/s, and 16 mm/s) when the Final RPM is held constant at 1500 rpm. A limit range 1010e is shown for the [Nozzle Move/Rot (mm)] that can range from approximately 0.29 mm to approximately 0.42 mm. In addition, a predicted defect radius range 1015e is shown for the 8 mm/s scan rate (1020e) that can range from approximately 95 mm to approximately 128 mm.

In some embodiments, the exemplary data shown in FIGS. 10A-10E can be used to identify limits that can be used to establish a successful rinsing procedure. For example, the [Nozzle Move/Rot (mm)] limits and the predicted defect radius ranges shown in FIGS. 10A-10E may be used to create a rinsing model and/or establish limits for a successful rinsing procedure. In some examples, the calculated NMpR values can be different from those shown in FIGS. 10A-10E. The present invention provides rinsing models that can use one or more sets of rinsing-related data to calculate and/or predict NMpR limits and defect radius ranges. The rinsing-related data can include chamber data, defect count data, nozzle scan speed data (mm/s), final RPM data, maximum RPM data, minimum RPM data, variable RPM data, acceleration data, defect radius data (mm), RPM breakup data, angular velocity data (mm/s), [d(t)/d(rot)] data, and (nozzle move/rot (mm)) data. In addition, the rinsing-related data can include photoresist data that can include material data, thickness data, uniformity data, optical data, CD data, SWA data, PEB data, or PAB data, or any combination thereof. Furthermore, the rinsing-related data can include developing data, cleaning data, drying data, chamber matching data, wafer thickness data, or wafer curvature data, or any combination thereof.

By using measured and/or simulated values of the NMpR at different defect transition radii, the methods of the invention can be used to predict a maximum NMpR below which no defect formation results. Knowing the maximum NMpR below which no defect results allows selection of recipe conditions to maintain nozzle scan speed and wafer rotation rate such that no defects are formed.

In addition, the invention can be used to optimize recipe throughput, by reducing the total recipe time, while forming no defects. Recipe throughput optimization is achieved by changing the nozzle scan speed at a specific radius, identified through NMpR calculation and experiment, such that if nozzle scan speed were maintained beyond this radius defect formation would occur. Ideally, selecting a wafer rotation rate that allows maintaining a high-velocity nozzle scan speed as long as possible will achieve the greatest reduction in throughput.

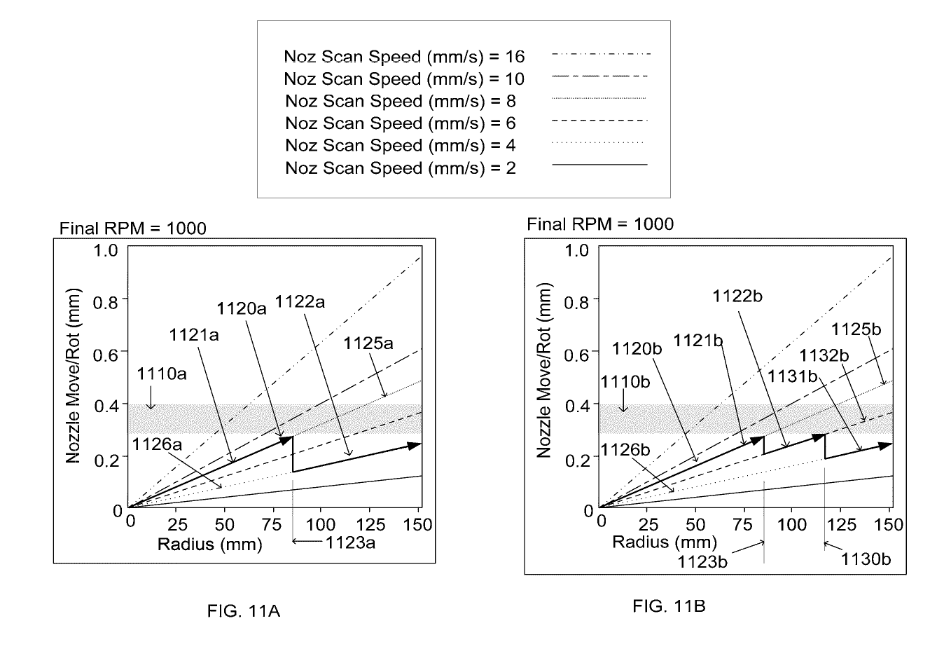

FIGS. 11A and 11B illustrate exemplary recipe throughput optimization data in accordance with embodiments of the invention. A first set of exemplary graphs are shown in FIG. 11A, that show simulated data [(Nozzle Move/Rot) versus (wafer radius)] for six different nozzle scan speeds (2 mm/s, 4 mm/s, 6 mm/s, 8 mm/s, 10 mm/s, and 16 mm/s) when the Final RPM is held constant at 1000 rpm. A limit range 1110a is shown for the [Nozzle Move/Rot (mm)] that can range from approximately 0.29 mm to approximately 0.42 mm. In addition, a first reduced time recipe 1120a is shown having a first portion 1121a, a second portion 1122a, and a switching radius 1123a that are established to shorten the time required for the rinsing recipe. During the first portion 1121a, the 8 mm/s scan rate (1125a) is used for the nozzle until the switching radius 1123a is reached, and during the second portion 1122a, the 4 mm/s scan rate (1126a) is used for the nozzle after the switching radius 1123a is exceeded. For example, the switching radius 1123a can range from approximately 80 mm to approximately 88 mm, the time for the first portion 1121a can range from approximately 10 seconds to approximately 11 seconds, the time for the second portion 1122a can range from approximately 15.4 seconds to approximately 17.5 seconds, and the total time can range from approximately 25 seconds to approximately 28 seconds.

A second set of exemplary graphs are shown in FIG. 11B, that show simulated data [(Nozzle Move/Rot) versus (wafer radius)] for six different nozzle scan speeds (2 mm/s, 4 mm/s, 6 mm/s, 8 mm/s, 10 mm/s, and 16 mm/s) when the Final RPM is held constant at 1000 rpm. A limit range 1110b is shown for the [Nozzle Move/Rot (mm)] that can range from approximately 0.29 mm to approximately 0.42 mm. In addition, a second reduced time recipe 1120b is shown having a first portion 1121b, a second portion 1122b, a first switching radius 1123b, a third portion 1131b, and a second switching radius 1130b that are established to shorten the time required for the rinsing recipe During the first portion 1121b, the 8 mm/s scan rate (1125b) is used for the nozzle until the first switching radius 1123b is reached, during the second portion 1122b, the 6 mm/s scan rate (1132b) is used for the nozzle after the switching radius 1123b is exceeded, and during the third portion 1131b, the 4 mm/s scan rate (1126b) is used for the nozzle after the second switching radius 1130b is exceeded. For example, the first switching radius 1123b can range from approximately 80 mm to approximately 88 mm, and the time for the first portion 1121b can range from approximately 10 seconds to approximately 11 seconds. The second switching radius 1123b can range from approximately 115 mm to approximately 120 mm, the time for the second portion 1121b can range from approximately 5 seconds to approximately 6 seconds, and the time for the third portion 1131b can range from approximately 7.5 seconds to approximately 8.5 seconds, and the total time can range from approximately 22.5 seconds to approximately 25.5 seconds.

In some embodiments, the exemplary data shown in FIG. 11A and FIG. 11B can be used to identify limits that can be used to establish a successful rinsing procedure that can use one or more different scan speed to reduce the time required for the rinse procedure. For example, the [Nozzle Move/Rot (mm)] limits, the predicted defect radius ranges, and the different scan speeds shown in FIG. 11A and FIG. 11B may be used to create a rinsing model and/or establish limits for a faster rinsing procedure. In some examples, the calculated NMpR values can be different from those shown in FIG. 11A and FIG. 11B. The present invention provides rinsing models that can use one or more sets of rinsing-related data to calculate and/or predict NMpR limits, defect radius ranges, and nozzle scan speeds. The rinsing-related data can include chamber data, defect count data, nozzle scan speed data (mm/s), final RPM data, maximum RPM data, minimum RPM data, variable RPM data, acceleration data, defect radius data (mm), RPM breakup data, angular velocity data (mm/s), [d(t)/d(rot)] data, and (nozzle move/rot (mm)) data. In addition, the rinsing-related data can include photoresist data that can include material data, thickness data, uniformity data, optical data, CD data, sidewall angle (SWA) data, post exposure bake (PEB) data, or post application bake (PAB) data, or any combination thereof. Furthermore, the rinsing-related data can include developing data, cleaning data, drying data, chamber matching data, wafer thickness data, or wafer curvature data, or any combination thereof.

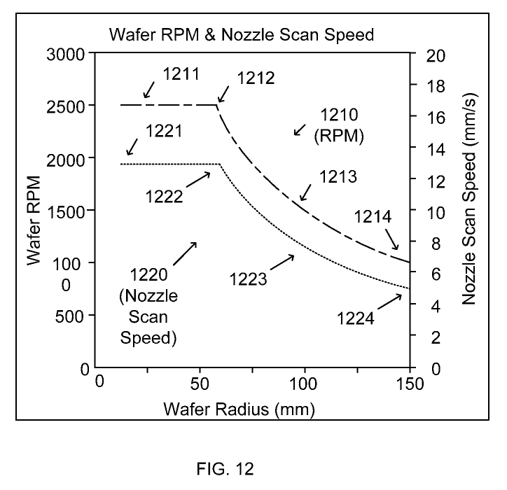

FIG. 12 illustrates exemplary wafer rotation and nozzle scan speed optimization data in accordance with embodiments of the invention. A first exemplary graph 1210 is shown where RPM data is plotted versus wafer radius (mm) data, and a second exemplary graph 1220 is shown where nozzle scan speed (mm/s) data is plotted versus wafer radius (mm) data. An exemplary maximum RPM value 1211 is shown, and the exemplary maximum RPM value 1211 is shown as 2500 rpm. The maximum RPM value 1211 can range from approximately 2000 rpm to approximately 3000 rpm. For example, the maximum RPM value 1211 can be dependent upon the rotational speeds associated with translation unit (404, FIG. 4) and the scan speed associated with the dispensing subsystem (460, FIG. 4) being used. An exemplary RPM breakpoint value 1212 is shown, and the exemplary RPM breakpoint value 1212 is shown at a wafer radius of 60 mm. The position of the RPM breakpoint value 1212 can range from a radius of approximately 50 mm to approximately 100 mm. For example, the RPM breakpoint value 1212 can be dependent upon the calculated NMpR values. In addition, exemplary variable RPM values 1213 are shown, and the exemplary variable RPM values 1213 can have a linear or a non-linear slope. Furthermore, an exemplary RPM endpoint 1214 is shown, and the exemplary RPM endpoint 1214 is shown at a wafer radius of 150 mm. The value of the RPM endpoint 1214 can range from a value of approximately 800 rpm to approximately 1500 rpm.

An exemplary maximum nozzle scan speed value 1221 is shown, and the exemplary maximum nozzle scan speed value 1221 is shown as 13 mm/s. The nozzle scan speed can range from approximately 2 mm/s to approximately 30 mm/s. For example, the maximum nozzle scan speed value 1221 can be dependent upon the rotational speeds associated with translation unit (404, FIG. 4) and the scan speed associated with the dispensing subsystem (460, FIG. 4) being used. An exemplary nozzle scan speed breakpoint value 1222 is shown, and the exemplary nozzle scan speed breakpoint value 1222 is shown at a wafer radius of 60 mm. The position of the nozzle scan speed breakpoint 1221 can range from a radius of approximately 50 mm to approximately 100 mm. For example, the nozzle scan speed breakpoint value 1222 can be dependent upon the calculated NMpR values. In addition, exemplary variable nozzle scan speeds 1223 are shown, and the exemplary nozzle scan speeds 1223 can have a linear or a non-linear slope. Furthermore, an exemplary nozzle scan speed endpoint 1224 is shown, and the exemplary nozzle scan speed endpoint 1224 is shown at a wafer radius of 150 mm. The value of the nozzle scan speed endpoint 1224 can range from a value of approximately 4 mm/s to approximately 6 mm/s.

In some examples, it is possible to further optimize recipe throughput by calculating a continuous change in wafer rotation rate and a continuous change in nozzle scan speed to maintain a constant NMpR below the transition value.

In first exemplary sequences: a1) a first wafer (patterned or un-patterned) can be coupled to a wafer table; b1) a first wafer position can be determined as the wafer is rotated at a first constant angular velocity during a first time; c1) the dispensing subsystem 460 can be positioned at a first location proximate the center of the wafer during the first time, and the first location can be determined using the first wafer position; d1) a first amount of a first rinsing fluid or gas can be applied to an inner region on the top surface of the wafer as the rinse nozzle assembly 461 in the dispensing subsystem 460 is scanned across the inner region at a first scan speed during a second time, and the wafer can be rotated at the first constant angular velocity during the second time; e1) a second amount of a second rinsing fluid or gas can be applied to a outer region on the top surface of the wafer as the rinse nozzle assembly 461 in the dispensing subsystem 460 is scanned across the outer region at the first scan speed during a third time, and the wafer can be rotated at the first constant angular velocity during the third time; and f1) the wafer rotation can be stopped during a fourth time.

In second exemplary sequences: a2) a first wafer (patterned or un-patterned) can be coupled to a wafer table; b2) a first wafer position can be determined as the wafer is rotated at a first constant angular velocity during a first time; c2) the dispensing subsystem 460 can be positioned at a first location proximate the center of the wafer during the first time, and the first location can be determined using the first wafer position; d2) a first amount of a first rinsing fluid or gas can be applied to an inner region on the top surface of the wafer as the rinse nozzle assembly 461 in the dispensing subsystem 460 is scanned across the inner region at a first scan speed during a second time, and the wafer can be rotated at the first constant angular velocity during the second time; e2) a second amount of a second rinsing fluid or gas can be applied to a outer region on the top surface of the wafer as the rinse nozzle assembly 461 in the dispensing subsystem 460 is scanned across the outer region at a second scan speed during a third time, and the wafer can be rotated at the first constant angular velocity during the third time; and f2) the wafer rotation can be stopped during a fourth time.

In third exemplary sequences: a3) a first wafer (patterned or un-patterned) can be coupled to a wafer table; b3) a first wafer position can be determined as the wafer is rotated at a first constant angular velocity during a first time; c3) the dispensing subsystem 460 can be positioned at a first location proximate the center of the wafer during the first time, and the first location can be determined using the first wafer position; d3) a first amount of a first rinsing fluid or gas can be applied to an inner region on the top surface of the wafer as the rinse nozzle assembly 461 in the dispensing subsystem 460 is scanned across the inner region at a first scan speed during a second time, and the wafer can be rotated at the first constant angular velocity during the second time; e3) a second amount of a second rinsing fluid or gas can be applied to a middle region on the top surface of the wafer as the rinse nozzle assembly 461 in the dispensing subsystem 460 is scanned across the middle region at a second scan speed during a third time, and the wafer can be rotated at the first constant angular velocity during the third time; f3) a third amount of a third rinsing fluid or gas can be applied to a outer region on the top surface of the patterned wafer as the rinse nozzle assembly 461 in the dispensing subsystem 460 is scanned across the outer region at a third scan speed during a fourth time, and the wafer can be rotated at the first constant angular velocity during the fourth time; and g3) the wafer rotation can be stopped during a fifth time.

In fourth exemplary sequences: a4) a first wafer (patterned or un-patterned) can be coupled to a wafer table; b4) the center of the first wafer can be determined as the wafer is rotated at a first constant angular velocity during a first time; c4) the dispensing subsystem 460 can be positioned at a first location proximate the center of the wafer during the first time, and the first location can be determined using the previously determined center of first wafer; d4) a first amount of a first rinsing fluid can be applied to an inner region on the top surface of the wafer as the rinse nozzle assembly 461 in the dispensing subsystem 460 is scanned across the inner region at a first scan speed during a second time, and the wafer can be rotated at the first constant angular velocity during the second time; e4) a second amount of a second rinsing fluid can be applied to a outer region on the top surface of the wafer as the rinse nozzle assembly 461 in the dispensing subsystem 460 is scanned across the outer region at a second scan speed during a third time, and the wafer can be rotated at the first constant angular velocity during the third time; f4) the dispensing subsystem 460 can be re-positioned at the first location proximate the center of the wafer during a fourth time; g4) a first amount of a first rinsing gas can be applied to an inner region on the top surface of the wafer as the process gas nozzle assembly 462 in the dispensing subsystem 460 is scanned across the inner region at a first scan speed during a fifth time, and the wafer can be rotated at a second constant angular velocity during the fifth time; h4) a second amount of a second rinsing gas can be applied to a outer region on the top surface of the wafer as the process gas nozzle assembly 462 in the dispensing subsystem 460 is scanned across the outer region at a second scan speed during a sixth time, and the wafer can be rotated at the second constant angular velocity during the sixth time; and i4) the wafer rotation can be stopped during a seventh time.

In fifth exemplary sequences: a5) a first wafer (patterned or un-patterned) can be coupled to a wafer table; b5) a first wafer position can be determined as the wafer is rotated at a first constant angular velocity during a first time; c5) the dispensing subsystem 460 can be positioned at a first location proximate the center of the wafer during the first time, and the first location can be determined using the first wafer position; d5) the rinse nozzle assembly 461 can provide a first amount of a first rinsing fluid and the process gas nozzle assembly 462 can provide a first amount of a rinsing gas to an inner region on the top surface of the wafer as the rinse nozzle assembly 461 and the process gas nozzle assembly 462 in the dispensing subsystem 460 are scanned across the inner region at a first scan speed during a second time, and the wafer can be rotated at the first constant angular velocity during the second time; e5) the rinse nozzle assembly 461 can provide a second amount of a second rinsing fluid and the process gas nozzle assembly 462 can provide a second amount of a rinsing gas to an outer region on the top surface of the wafer as the rinse nozzle assembly 461 and the process gas nozzle assembly 462 in the dispensing subsystem 460 are scanned across the outer region at a second scan speed during a third time; and f5) the wafer rotation can be stopped during a fourth time.

In sixth exemplary sequences: a6) a first wafer (patterned or un-patterned) can be coupled to a wafer table; b6) a first wafer center can be determined as the wafer is rotated at a first constant angular velocity during a first time; c6) the dispensing subsystem 460 can be positioned at a first location proximate the center of the wafer during the first time, and the first location can be determined using the determined wafer center position; d6) the rinse nozzle assembly 461 can provide a first amount of a first cleaning fluid and/or a first amount of a cleaning gas to an inner region on the top surface of the wafer as the rinse nozzle assembly 461 in the dispensing subsystem 460 is scanned across the inner region at a first scan speed during a second time, and the wafer can be rotated at the first constant angular velocity during the second time; e6) the rinse nozzle assembly 461 can provide a second amount of a second cleaning fluid and/or a second amount of a cleaning gas to an outer region on the top surface of the wafer as the rinse nozzle assembly 461 in the dispensing subsystem 460 is scanned across the outer region at a second scan speed during a third time; f6) the dispensing subsystem 460 can be re-positioned at the first location proximate the center of the wafer during the fourth time; g6) the rinse nozzle assembly 461 can provide a first amount of a first rinsing fluid and/or a first amount of a rinsing gas to an inner region on the top surface of the wafer as the rinse nozzle assembly 461 in the dispensing subsystem 460 is scanned across the inner region at a first scan speed during a fifth time, and the wafer can be rotated at the first constant angular velocity during the fifth time; h6) the rinse nozzle assembly 461 can provide a second amount of a second rinsing fluid and/or a second amount of a rinsing gas to an outer region on the top surface of the wafer as the rinse nozzle assembly 461 in the dispensing subsystem 460 is scanned across the outer region at a second scan speed during a sixth time; and i6) the wafer rotation can be stopped during a seventh time.

The rinsing sequences of the invention are faster and provide a substantially smaller amount of foreign material. The various steps in the rinsing sequences can have durations that can vary from approximately 0.1 second to approximately 60 seconds, the flow rates for rinsing fluids can vary from approximately 0 milliliter/second to approximately 10 milliliter/second, and the flow rates for gasses can vary from approximately zero sccm to approximately 100 sccm.

In some embodiments, rinsing system can be configured with a washing means to clean one or more of the cleaning assemblies and associated elements. For example, a test wafer can be held and spun at a low speed during a cleaning time specified in a process recipe, and the dispensing subsystem 460 can dispense a solvent to clean one or more of the nozzles.

One or more of the controllers described herein may be coupled to a system controller (not shown) capable of providing data to the rinsing system. The data can include wafer information, layer information, process information, and metrology information. Wafer information can include composition data, size data, thickness data, and temperature data. Layer information can include the number of layers, the composition of the layers, and the thickness of the layers. Process information can include data concerning previous steps and the current step. Metrology information can include optical digital profile data, such as critical dimension (CD) data, profile data, and uniformity data, and optical data, such as refractive index (n) data and extinction coefficient (k) data. For example, CD data and profile data can include information for features and open areas in one or more layers, and can include uniformity data. Each controller may comprise a microprocessor, a memory (e.g., volatile and/or non-volatile memory), and a digital I/O port. A program stored in the memory may be utilized to control the aforementioned components of a rinsing system according to a process recipe. A controller may be configured to analyze the process data, to compare the process data with target process data, and to use the comparison to change a process and/or control the processing system components.

In some embodiments, one or more of the nozzle assemblies can be removably coupled to the dispensing subsystem 460 to allow the nozzle assemblies to be removed, cleaned, and/or replaced during maintenance procedures. Flow controllers (not shown) can be used to control the types of fluids and/or gasses provided to the nozzle assemblies, and the flow rates for the supplied fluids and/or gasses.

The system and methods of the invention can be used without damaging and/or altering the semiconductor materials, dielectric materials, low-k materials, and ultra-low-k materials.

In other embodiments, one or more cleaning stations 490 can be provided, and the cleaning stations can be used during a self-cleaning procedure. For example, a fully automated self-cleaning process can be implemented to minimize human intervention and potential error. If customer defect levels require the rinsing system to be cleaned periodically, this can be programmed to occur. Down time and productivity lost due to Preventative Maintenance (PM) cleaning activities are minimized since the fully automated cleaning process/design allows the cleaning cycle to occur without stopping the entire tool. In addition, since the tools is not “opened” or disassembled, no post cleaning process testing (verification) is required. Furthermore, maintenance personnel are not exposed to solvent vapors, polymer residues or potential lifting or handling injuries since the components are not removed and/or cleaned by maintenance personnel. In other cases, one or more of the rinsing system components may be cleaned using external cleaning procedures. The self-cleaning frequency and the self-cleaning process can be programmable and can be executed based on time, number of wafers processed or exhaust values (alarm condition or minimum exhaust value measured during processing). Nitrogen or any other gas can also be used during a self-cleaning step.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative system and methods, and illustrative examples shown and described. Accordingly, departures may be made from such details without departing from the scope of applicants' general inventive concept.

What is claimed is:

1. A method of processing a wafer comprising:
positioning a patterned wafer on a wafer table in a processing chamber, the patterned wafer having a plurality of photoresist features thereon, wherein one or more surfaces of the photoresist features have residue material thereon;
rotating the patterned wafer at a first rotation rate, wherein a wafer center is determined;
positioning a rinsing nozzle assembly in a dispensing subsystem proximate the wafer center, wherein the dispensing subsystem comprises at least one process gas nozzle assembly, at least one dispensing nozzle assembly, and the rinsing nozzle assembly;
performing a first rinsing procedure in an inner region of the patterned wafer, wherein the patterned wafer is rotated at the first rotation rate as the rinsing nozzle assembly moves through the inner region at a first scan speed towards a wafer edge, the rinsing nozzle assembly providing a first rinsing fluid to a rinsing space proximate a wafer surface at a first flow rate;
performing a second rinsing procedure in an outer region of the patterned wafer, wherein the patterned wafer is rotated at a second rotation rate as the rinsing nozzle assembly moves through the outer region at a second scan speed towards the wafer edge, the rinsing nozzle assembly providing a second rinsing fluid to the rinsing space proximate the wafer surface at a second flow rate;
determining a first processing state for the patterned wafer, the first processing state being a first value when at least one residue streak is present on a top wafer surface of the patterned wafer and being a second value when one or more residue streaks are not present on the top wafer surface of the patterned wafer;
performing a corrective action, if the first processing state is the first value; and
removing the wafer from the processing chamber, if the first processing state is the second value.

2. The method of claim 1, wherein a first contact angle associated with the first rinsing fluid is used in the inner region and a second contact angle is used in the outer region.

3. The method of claim 1, wherein the inner region and the outer region are determined using exposure data.

4. The method of claim 1, wherein the inner region and the outer region are determined using defect radius data.

5. The method of claim 1, wherein the second scan speed is slower than the first scan speed, wherein the first scan speed ranges from approximately 2 mm/s to approximately 200 mm/s and the second scan speed ranges from approximately 1 mm/s to approximately 100 mm/s.

6. The method of claim 1, wherein the first rotation rate is a first constant angular velocity and the second rotation rate is a second constant angular velocity different than the first constant angular velocity, wherein the first constant angular velocity ranges from approximately 10 revolutions per minute (rpms) to approximately 2000 revolutions per minute (rpms) and the second constant angular velocity ranges from approximately 10 revolutions per minute (rpms) to approximately 2000 revolutions per minute (rpms).

7. The method of claim 1, wherein the first rotation rate is a first constant angular velocity and the second rotation rate is a second constant angular velocity substantially equal to the first constant angular velocity, wherein the first constant angular velocity ranges from approximately 10 revolutions per minute (rpms) to approximately 2000 revolutions per minute (rpms) and the second constant angular velocity ranges from approximately 10 revolutions per minute (rpms) to approximately 2000 revolutions per minute (rpms).

8. The method of claim 1, wherein the rinsing nozzle assembly has a first length I₁ and a first angle φ₁ associated therewith, the first length I₁ ranging from approximately 5 mm to approximately 50 mm, and the first angle φ₁ ranging from approximately 10 degrees to approximately 110 degrees; the process gas nozzle assembly has a second length I₂ and a second angle φ₂ associated therewith, the second length I₂ ranging from approximately 5 mm to approximately 50 mm, and the second angle φ₂ ranging from approximately 10 degrees to approximately 110 degrees; and the dispensing nozzle assembly has a third length I₃ and a third angle φ₃ associated therewith, the third length I₃ ranging from approximately 5 mm to approximately 50 mm, and the third angle φ₃ ranging from approximately 10 degrees to approximately 110 degrees.

9. The method of claim 1, wherein the rinsing nozzle assembly has a first dispensing tip D₁ associated therewith, the first dispensing tip D₁ having an inside diameter between approximately 0.1 mm and approximately 2.0 mm and having an outside diameter between approximately 0.5 mm to approximately 5.0 mm.

10. The method of claim 9, wherein the first dispensing tip D₁ is positioned at a first separation distance s₁ above a top surface of the wafer table, the first separation distance s₁ ranging from approximately 2 mm to approximately 25 mm.

11. The method of claim 1, wherein the process gas nozzle assembly has a second dispensing tip D₂ associated therewith, the second dispensing tip D₂ having an inside diameter between approximately 0.1 mm and approximately 2.0 mm and having an outside diameter between approximately 0.5 mm to approximately 5.0 mm.

12. The method of claim 11, wherein the second dispensing tip D₂ is positioned at a second separation distance s₂ above a top surface of the wafer table, the second separation distance s₂ ranging from approximately 2 mm to approximately 25 mm.

13. The method of claim 1, wherein the dispensing nozzle assembly has a third dispensing tip D₃ associated therewith, the third dispensing tip D₃ having an inside diameter between approximately 0.1 mm and approximately 2.0 mm and having an outside diameter between approximately 0.5 mm to approximately 15.0 mm.

14. The method of claim 13, wherein the third dispensing tip D₃ is positioned at a third separation distance s₃ above a top surface of the wafer table, the third separation distance s₃ ranging from approximately 2 mm to approximately 25 mm.

15. A rinsing system comprising:
wafer transfer port coupled to a processing chamber, wherein the wafer transfer port is opened during wafer transfer procedures and closed during wafer processing procedures;
wafer table configured within the processing chamber and configured to hold a patterned wafer having a plurality of photoresist features thereon, wherein one or more surfaces of the photoresist features have residue material thereon;
translation unit coupled to the wafer table and the processing chamber, the translation unit being configured to rotate the wafer table and the patterned wafer at a first rotation rate;
control subsystem coupled to the processing chamber
one or more flexible arms coupled to the control subsystem, wherein the flexible arms include one or more first supply elements, one or more coupling elements, and one or more second supply elements;
dispensing subsystem coupled to at least one of the flexible arms, wherein the dispensing subsystem comprises a rinsing nozzle assembly, a process gas nozzle assembly, and a dispensing nozzle assembly, wherein the control subsystem, the flexible arms, and the dispensing subsystem are configured to position the rinsing nozzle assembly in the dispensing subsystem proximate a wafer center during a first time, wherein the dispensing subsystem comprises at least one process gas nozzle assembly, at least one dispensing nozzle assembly, and the rinsing nozzle assembly,
wherein the control subsystem, the flexible arms, and the dispensing subsystem are configured to scan the rinsing nozzle assembly through an inner region of the patterned wafer at a first scan speed during a second time, the translation unit being configured to rotate the wafer table at the first rotation rate during the second time, wherein the rinsing nozzle assembly is configured to provide a first rinsing fluid to a first rinsing space proximate a wafer surface at a first flow rate during the second time;
wherein the control subsystem, the flexible arms, and the dispensing subsystem are further configured to scan the rinsing nozzle assembly through an outer region of the patterned wafer at a second scan speed during a third time, the translation unit being configured to rotate the wafer table at the second rotation rate during the third time, wherein the rinsing nozzle assembly is configured to provide a second rinsing fluid to a second rinsing space proximate the wafer surface at a second flow rate during the third time; and
controller coupled to the processing chamber, the translation unit, the wafer table, the flexible arms, and the dispensing subsystem, wherein the controller is configured to determine a first processing state for the patterned wafer, the first processing state being a first value when at least one residue streak is present on a top wafer surface and being a second value when at least one or more residue streaks are not present on the top wafer surface, the controller performing a corrective action, if the first processing state is the first value and removing the wafer from the processing chamber, if the first processing state is the second value.

16. The rinsing system of claim 15, wherein the first rotation rate is a first constant angular velocity and the second rotation rate is a second constant angular velocity substantially equal to the first constant angular velocity, wherein the first constant angular velocity ranges from approximately 10 revolutions per minute (rpms) to approximately 2000 revolutions per minute (rpms) and the second constant angular velocity ranges from approximately 10 revolutions per minute (rpms) to approximately 2000 revolutions per minute (rpms).

17. The rinsing system of claim 15, wherein the second scan speed is slower than the first scan speed, wherein the first scan speed ranges from approximately 2 mm/s to approximately 200 mm/s and the second scan speed ranges from approximately 1 mm/s to approximately 100 mm/s.

18. The rinsing system of claim 15, wherein the rinsing nozzle assembly has a first length I₁ and a first angle φ₁ associated therewith, the first length I₁ ranging from approximately 5 mm to approximately 50 mm, and the first angle φ₁ ranging from approximately 10 degrees to approximately 110 degrees; the process gas nozzle assembly has a second length I₂ and a second angle φ₂ associated therewith, the second length I₂ ranging from approximately 5 mm to approximately 50 mm, and the second angle φ₂ ranging from approximately 10 degrees to approximately 110 degrees; and the dispensing nozzle assembly has a third length I₃ and a third angle φ₃ associated therewith, the third length I₃ ranging from approximately 5 mm to approximately 50 mm, and the third angle φ₃ ranging from approximately 10 degrees to approximately 110 degrees.

19. The rinsing system of claim 15, wherein the rinsing nozzle assembly has a first dispensing tip D₁ associated therewith, the first dispensing tip D₁ having an inside diameter between approximately 0.1 mm and approximately 2.0 mm and having an outside diameter between approximately 0.5 mm to approximately 5.0 mm.

20. The rinsing system of claim 19, wherein the first dispensing tip D₁ is positioned at a first separation distance s₁ above a top surface of the wafer table, the first separation distance s₁ ranging from approximately 2 mm to approximately 25 mm.
